(19) United States
(12) Patent Application Publication
(10) Pub. No.: US 2026/0315987 A1
(43) Pub. Date: Oct. 15, 2026

(54) LIQUID RECLAMATION AND SOLID FOAM RECYCLING/RECLAMATION: COMPOSITIONS AND METHODS

(71) Applicant: THE CHEMOURS COMPANY FC, LLC, WILMINGTON, DE (US)

(72) Inventors: SHENG PENG, HOCKESSIN, DE (US); JEFFREY B. SOWDER, CLAYTON, DE (US); BARBARA HAVILAND MINOR, THE VILLAGES, FL (US); JIAN SUN-BLANKS, ARAB, AL (US); ANDREW R. PANSULLA, WEST CHESTER, PA (US); JOSHUA HUGHES, WILMINGTON, DE (US); DAVID MATTHEW SNYDER, DREXEL HILL, PA (US); ANTHONY F. STASIO, NEWARK, DE (US); RAYMOND WU, MOUNT LAUREL, NJ (US)

(73) Assignee: THE CHEMOURS COMPANY FC, LLC, WILMINGTON, DE (US)

(21) Appl. No.: 19/106,608

(22) PCT Filed: Aug. 30, 2023
(86) PCT No.: PCT/US2023/031480

§ 371 Date: Feb. 25, 2025

Related U.S. Application Data
(60) Provisional application No. 63/402,727, filed on Aug. 31, 2022.

(51) Int. Cl. B01D 53/04; B29B 9/08; B29B 17/04; B29K 75/00; B29K 105/04; B29K 105/26; C09K 5/04

(52) U.S. Cl. CPC B01D 53/0446; B29B 9/08; C09K 5/044; B01D 2256/26; B01D 2258/02; B29B 2017/0468; B29K 2075/00; B29K 2105/04; B29K 2105/26

(57) ABSTRACT

Methods and systems for reclaiming spent liquid and solid materials 100 formed using or including, but not limited to, haloolefin liquid refrigerants, solvents, immersion fluids and foam, are provided. Reclaimed compositions and components which meet the quality of AHRI_700_2019 industry standards are also provided.

### CROSS REFERENCE TO RELATED APPLICATIONS

This application claims priority to U.S. Patent Application No. 63/402,727 filed Aug. 31, 2022, the disclosure of which is herein incorporated by reference in its entirety.

### FIELD

The present invention relates to halogenated liquid and foam waste reclamation where spent halogenated liquids, such as refrigerants, solvents, immersion fluids, and foam wastes are reclaimed by physical and/or chemical treatments, converted to high purity components, compositions and products, and optionally compositionally rebalanced to meet the quality requirements of AHRI_700_2019 for reuse and recycle.

### BACKGROUND

The popularity of the circular economy concept and its adoption to reduce waste have generated significant attention. Halogenated olefins, e.g., hydrochloroolefins (HCO), chlorofluoroolefin (CFO), hydrofluoroolefins (HFOs), hydrochlorofluoroolefins (HCFOs) have been developed and are currently being used to replace chlorofluorocarbons (CFCs), hydrochlorofluorocarbons (HCFCs), and hydrofluorocarbons (HFCs), thereby providing heat transfer medium having lower global warming potential (GWP) and ozone depleting potential (ODP) properties which need to be reclaimed. The halogenated olefins HCOs, HFOs and HCFOs, as well as fluorinated ethers, e.g., hydrofluoroether (HFE), fluoropolyether (PFPE, HFPE), hydrofluoroolefinic ether (HFOE), and hydrofluorocarbons (HFCs), collectively halogenated liquids, also find use as solvents, blowing agents, foam producing, cleaning and dielectric fluids for electronics which need to be reclaimed after use to reduce waste.

Thus, there continues to be a need to apply the circular economy concept to all halogenated liquids and provide integrated/comprehensive system and process for reclamation which will reduce liquid halogenated waste and foam wastes, and generate high purity and quality reclaimed liquids and compositions to meet at least AHRI_700_2019 standards, for recycle and use.

### SUMMARY

The present invention is directed to integrated reclamation methods which treat and convert spent (e.g., used, contaminated) halogenated liquids and spent foam waste into high purity liquids, compositions and solids which meet industry standards for reuse and recycling. These spent halogenated liquids and foam wastes are recovered (collected) from various sources, such as systems circulating heat transfer liquids, storage facilities, discarded sources of refrigerants, foam making facilities, foam recycle centers, etc. Physical and chemical properties of the spent liquids can be assessed, and treatments selected to remove contaminants, moisture, water, acidity, gases, e.g., air, oil, particulates/solids, stabilizers, etc., and provide high purity halogenated liquid components and mixtures/blends. For levels of unsolubilized water above the saturation point in the halogenated liquids, distillation or decanting may also be used. Moisture removal can involve the use of molecular sieves or decanting or the combination of these two. Distillation can be used to separate and/or purify liquid mixtures and liquid components of the spent halogenated liquids, for example separate R-514A into dichloroethylene (R-1130) and 1,1,1,4,4,4-hexafluorobut-2-ene (Z-1336mzz).

Disclosed herein are integrated processes for the reclamation and production of high purity refrigerants, refrigerant blends, solvents, immersion liquids, polymers, including but not limited to the liquids identified in Table 1.

TABLE 1

| Acronyms | Chemical name | Structure |
|---|---|---|
| | trifluoroacetone | CF3C(O)CH3 |
| R-1130(E) | E 1,2-dichloroethene | E-CHCl═CHCl |
| HFO-E/Z-1336mzz | E 1,1,1,4,4,4-hexafluorobut-2-ene | E/Z CF3CH═CHCF3 |
| | Z 1,1,1,4,4,4-hexafluorobut-2-ene | |
| HCFO-1224yd | E 1-chloro-2,3,3,3-tetrafluoroprop-1-ene | E/Z CF3CF═CHCl |
| | Z 1-chloro-2,3,3,3-tetrafluoroprop-1-ene | |
| HCFO-1233zd | E 1-chloro-3,3,3-trifluoropropene | E/Z-CHCl═CHCF3 |
| | Z 1-chloro-3,3,3-trifluoropropene | |
| R-514A | Z 1,1,1,4,4,4-hexafluorobut-2-ene + | CF3CH═CHCF3 + |
| | E 1,2-dichloroethene | CHCl═CHCl |
| R-245fa | 1,1,1,3,3-pentafluoropropane | CF3CH2CHF2 |
| R-365mfc | 1,1,1,3,3-pentafluorobutane | CF3CH2CF2CH3 |
| F22E (HFO-153- | 1,1,1,2,2,5,5,6,6,6-decafluorohex-3-ene | C2F5CH═CHC2F5 |
| 10mczz) | | |
| F13iE | 1,1,1,4,5,5,5-heptafluoro-4- | CF3CF(CF3)CH═CHCF3 |
| | (trifluoromethyl)pent-2-ene | |
| F33E | 1,1,1,2,2,3,3,6,6,7,7,8,8,8-tetradecafluoro- | C2F5CF2CH═CHCF2C2F5 |
| | 4-octene | |
| F44E | 1,1,1,2,2,3,3,4,4,7,7,8,8,9,9,10,10,10- | CF3(CF2)3CH═CH—(CF2)3CF3 |
| | octadecafluorodec-5-ene | |
| Vertrel XF | 2,3-dihydrodecafluoropentane | CF3CF2CFHCFHCF3 |
| | methoxytridecafluoroheptene isomers | |
| | methoxynonafluoropentene isomers | |
| | E Dichloroethylene | CHCl═CHCl |
| | Perfluoro(3-ethyl-2-pentene): | CF3CF═C(C2F5)2 |
| | E perfluoro-2-pentene | E/Z CF3CF═CFC2F5 |
| | Z perfluoro-e-pentene | |
| | E perfluoro-3-heptene | E/Z-C2F5CF═CFCF2C2F5 |
| | Z perfluoro-3-heptene | |
| | E perfluoro-2-heptene | E/Z-CF3CF═CFC4F9 |
| | Z perfluoro-2-heptene | |
| Novec-7100 | methoxy-nonafluorobutane | C4F9OCH3 |
| Novec-7200 | ethoxy-nonafluorobutane | C4F9OC2H5 |
| Novec-7300 | 1,1,1,2,2,3,4,5,5,5-decafluoro 3-methoxy- | i-C3F7CF(OCH3)(C2F5) |
| | 4-(trfluoromethyl) pentane | |
| Novec-7500 | 3-ethoxy-1,1,1,2,3,4,4,5,5,6,6,6- | C3F7CF(OC2H5)(i-C3F7) |
| | dodecafluoro-2-(trifluoromethyl)hexane | |
| Novec-649 | dodecafluoro-2-methylpentan-3-one | i-C3F7C(═O)C2F5 |
| Novec 71DE | 50% methyl nonafluorobutyl ether | C4F9OCH3 |
| | 50% trans-1,2-dichloroethylene | (E)-ClCH═CHCl |
| Novec 71DA | 52.7% methyl nonafluorobutyl ether | C4F9OCH3 |
| | 44.6% trans-1,2-dichloroethylene | (E)-ClCH═CHCl |
| | 2.7% ethanol | CH3CH2OH |
| Novec 72DA | 10% methyl nonafluorobutyl ether | C4F9OCH3 |
| | 20% ethyl nonafluorobutyl ether | C4F9OC2H5 |
| | 68% trans-1,2-dichloroethylene | (E)-ClCH═CHCl |
| | 2% isopropanol | CH3CHOHCH3 |
| Novec 72DE | 10% methyl nonafluorobutyl ether | C4F9OCH3 |
| | 20% ethyl nonafluorobutyl ether | C4F9OC2H5 |
| | 70% trans-1,2-dichloroethylene | (E)-ClCH═CHCl |
| Novec 71IPA | 95.5% methyl nonafluorobutyl ether | C4F9OCH3 |
| | 4.5% isopropanol | CH3CHOHCH3 |
| Novec 73DE | 1,1,1,2,2,3,4,5,5,5-decafluoro 3-methoxy- | i-C3F7CF(OCH3)(C2F5) |
| | 4-(trfluoromethyl) pentane | |
| | trans-1,2-dichloroethylene | (E)-ClCH═CHCl |
| HFE-347 | 1,1,2,2-tetrafluoro-1-(2,2,2-trifluoroethoxy) | CF3CH2OCF2CF2H |
| | ethane | |

Disclosed herein are integrated processes for the reclamation and production of high purity refrigerants, refrigerant blends, solvents, immersion liquids, polymers, including but not limited to the liquids identified in Tables 2, 3 and 4.

TABLE 2

| Acronyms | Chemical name | Structure |
|---|---|---|
| CFO-1112 | 1,2-dichloro-1,2-difluoroethene | CFCl═CFCl |
| HCFO-1233zd (E) | (E)-1-chloro-3,3,3-trifluoropropene | (E) CF₃CH═CHCl |
| HCFO-1233zd (Z) | (Z)-1-chloro-3,3,3-trifluoropropene | (Z) CF₃CH═CHCl |
| HCFO-1224yd (E) | (E)-1-chloro-2,3,3,3-tetrafluoropropene | (E) CF₃CF═CHCl |
| HCFO-1224yd (Z) | (Z)-1-chloro-2,3,3,3-tetrafluoropropene | (Z) CF₃CF═CHCl |
| HFO-1234ze (Z) | (Z)-1,3,3,3-tetrafluoropropene | (Z) CF₃CH═CHF |
| HFO-1327mz (E) | (E)1,1,1,2,4,4,4-heptafluoro-2-butene | (E) CF₃CF═CHCF₃ |
| HFO-1327mz (Z) | (Z) 1,1,1,2,4,4,4-heptafluoro-2-butene | (Z)-CF₃CF═CHCF₃ |
| HFO-1336mzz (E) | (E)-1,1,1,4,4,4-hexafluoro-2-butene | (E)-CF₃CH═CHCF₃ |
| HFO-1336mzz (Z) | (Z)-1,1,1,4,4,4-hexafluoro-2-butene | (Z)-CF₃CH═CHCF₃ |
| HFO-1336yf | 2,3,3,4,4,4-Hexafluoro-1-butene | C₂F₅CF═CH₂ |
| HFO-1336ze (E) | (E)-1,3,3,4,4,4-Hexafluoro-1-butene | (E)-C₂F₅CH═CHCF |
| HFO-1336ze (Z) | (Z)-1,3,3,4,4,4-Hexafluoro-1-butene | (Z)-C₂F₅CH═CHCF |
| E-F12E | 1,1,1,4,4,5,5,5-octafluoropent-2-ene | (E)-C₂F₅CH═CHCF₃ |
| E-F13E | 1,1,1,4,4,5,5,6,6,6-decafluorohex-2-ene | (E) CF₃CH═CHCF₂C₂F₅ |
| E-F13iE | 1,1,1,4,5,5,5-heptafluoro-4- | CF₃CH═CHCF(CF₃)₂ |
| | (trifluoromethyl)pent-2-ene | |
| E-F22E | 1,1,1,2,2,5,5,6,6,6-decafluoropent-3-ene | (E)-C₂F₅CH═CHC₂F₅ |
| E-F44E | 1,1,1,2,2,3,3,4,4,7,7,8,8,9,9,10,10,10- | CF₃(CF₂)₃CH═CH—(CF₂)₃CF₃ |
| | octadecafluorodec-5-ene | |

TABLE 3

| Acronyms | Chemical name | Structure |
|---|---|---|
| F14E | 1,1,1,4,4,5,5,6,6,7,7,7- | CF₃CH═CH(CF₂)₃CF₃ |
| | dodecafluorohept-2-ene | |
| F14iE | 1,1,1,4,4,5,6,6,6-nonafluoro-5- | CF₃CH═CHCF₂CF—(CF3)₂ |
| | (trifluoromethyl)hex-2-ene | |
| F14sE | 1,1,1,4,5,5,6,6,6-nonfluoro-4- | CF₃CH═CHCF(CF₃)—C₂F₅ |
| | (trifluoromethyl)hex-2-ene | |
| F14tE | 1,1,1,5,5,5-hexafluoro-4,4- | CF₃CH═CHC(CF₃)₃ |
| | bis(trifluoromethyl)pent-2-ene | |
| F23E | 1,1,1,2,2,5,5,6,6,7,7,7- | C₂F₅CH═CHCF₂C₂F₅ |
| | dodecafluorohept-3-ene | |
| F23iE | 1,1,1,2,2,5,6,6,6-nonafluoro-5- | C₂F₅CH═CHCF(CF₃)₂ |
| | (trifluoromethyl)hex-3-ene | |
| F15E | 1,1,1,4,4,5,5,6,6,7,7,8,8,8- | CF₃CH═CH(CF₂)₄CF₃ |
| | tetradecafluorooct-2-ene | |
| F15iE | 1,1,1,4,4,5,5,6,7,7,7-undecafluoro-6- | CF₃CH═CH—CF₂CF₂CF(CF₃)₂ |
| | (trifluoromethyl)hept-2-ene | |
| F15tE | 1,1,1,5,5,6,6,6-octafluoro-4,4- | CF₃CH═CH—C(CF₃)₂C₂F₅ |
| | bis(trifluoromethyl)hex-2-ene | |
| F24E | 1,1,1,2,2,5,5,6,6,7,7,8,8,8- | C₂F₅CH═CH(CF₂)₃CF₃ |
| | tetradecafluorooct-3-ene | |
| F24iE | 1,1,1,2,2,5,5,6,7,7,7-undecafluoro-6- | C₂F₅CH═CHCF₂CF—(CF₃)₂ |
| | (trifluoromethyl)hept-3-ene | |
| F24sE | 1,1,1,2,2,5,6,6,7,7,7-undecafluoro-5- | C₂F₅CH═CHCF(CF₃)—C₂F₅ |
| | (trifluoromethyl)hept-3-ene | |
| F24tE | 1,1,1,2,2,6,6,6-octafluoro-5,5- | C₂F₅CH═CHC(CF₃)₃ |
| | bis(trifluoromethyl)hex-3-ene | |
| F33E | 1,1,1,2,2,3,3,6,6,7,7,8,8,8- | C₂F₅CF₂CH═CH—CF₂C₂F₅ |
| | tetradecafluorooct-4-ene | |
| F3i3iE | 1,1,1,2,5,6,6,6-octafluoro-2,5- | (CF₃)2CFCH═CH—CF(CF₃)₂ |
| | bis(trifluoromethyl)hex-3-ene | |
| F33iE | 1,1,1,2,5,5,6,6,7,7,7-undecafluoro-2- | C₂F₅CF₂CH═CH—CF(CF₃)₂ |
| | (trifluoromethyl)hept-3-ene | |
| F16E | 1,1,1,4,4,5,5,6,6,7,7,8,8,,9,9,9- | CF₃CH═CH(CF2)5CF3 |
| | hexadecafluoronon-2-ene | |
| F16sE | 1,1,1,4,5,5,6,6,7,7,8,8,8-tridecafluoro- | CF₃CH═CHCF(CF₃)(CF₂)2C₂F₅ |
| | 4-(trifluoromethyl)hept-2-ene | |
| F16tE | 1,1,1,6,6,6-octafluoro-4,4- | CF₃CH═CHC(CF₃)₂CF₂C₂F₅ |
| | bis(trifluoromethyl)hept-2-ene | |
| F25E | 1,1,1,2,2,5,5,6,6,7,7,8,8,9,9,9- | C₂F₅CH═CH(CF₂)₄CF₃ |
| | hexadecafluoronon-3-ene | |
| F25iE | 1,1,1,2,2,5,5,6,6,7,8,8,8-tridecafluoro- | C₂F₅CH═CH—CF₂CF₂CF(CF₃)₂ |
| | 7-(trifluoromethyl)oct-3-ene | |
| F25tE | 1,1,1,2,2,6,6,7,7,7-decafluoro-5,5- | C₂F₅CH═CH—C(CF₃)2C₂F₅ |
| | bis(trifluoromethyl)hept-3-ene | |
| F34E | 1,1,1,2,2,3,3,6,6,7,7,8,8,9,9,9- | C₂F₅CF2CH═CH—(CF₂)3CF₃ |
| | hexadecafluoronon-4-ene | |
| F34iE | 1,1,1,2,2,3,3,6,6,7,8,8,8-tridecafluoro- | C₂F₅CF₂CH═CH—CF₂CF(CF₃)₂ |
| | 7-(trifluoromethyl)oct-4-ene | |
| F34sE | 1,1,1,2,2,3,3,6,7,7,8,8,8-tridecafluoro- | C₂F₅CF₂CH═CH—CF(CF₃)C₂F₅ |
| | 6-(trifluoromethyl)oct-4-ene | |
| F34tE | 1,1,1,5,5,6,6,7,7,7-decafluoro-2,2- | C₂F₅CF₂CH═CH—C(CF₃)3 |
| | bis(trifluoromethyl)hept-3-ene | |
| F3i4E | 1,1,1,2,5,5,6,6,7,7,8,8,8-tridecafluoro- | (CF₃)₂CFCH═CH—(CF₂)3CF₃ |
| | 2(trifluoromethyl)oct-3-ene | |
| F3i4iE | 1,1,1,2,5,5,6,7,7,7-decafluoro-2,6- | (CF₃)₂CFCH═CH—CF₂CF(CF₃)₂ |
| | bis(trifluoromethyl)hept-3-ene | |
| F3i4sE | 1,1,1,2,5,6,6,7,7,7-decafluoro-2,5- | (CF3)2CFCH═CH—CF(CF₃)C₂F₅ |
| | bis(trifluoromethyl)hept-3-ene | |
| F3i4tE | 1,1,1,2,6,6,6-heptafluoro-2,5,5- | (CF₃)₂CFCH═CH—C(CF₃)₃ |
| | tris(trifluoromethyl)hex-3-ene | |
| F26E | 1,1,1,2,2,5,5,6,6,7,7,8,8,9,9,10,10,10- | C₂F₅CH═CH(CF₂)5CF₃ |
| | octadecafluorodec-3-ene | |
| F26sE | 1,1,1,2,2,5,6,6,7,7,8,8,9,9,9- | C₂F₅CH═CHCF(CF₃)(CF₂)₂C₂F₅ |
| | pentadecafluoro-5- | |
| | (trifluoromethyl)non-3-ene | |
| F26tE | 1,1,1,2,2,6,6,7,7,8,8,8-dodecafluoro- | C₂F₅CH═CHC(CF₃)2CF₂C₂F₅ |
| | 5,5-bis(trifluoromethyl)oct-3-ene | |
| F35E | 1,1,1,2,2,3,3,6,6,7,7,8,8,9,9,10,10,10- | C₂F₅CF₂CH═CH—(CF₂)4CF₃ |
| | octadecafluorodec-4-ene | |
| F35iE | 1,1,1,2,2,3,3,6,6,7,7,8,9,9,9- | C₂F₅CF2CH═CH—CF₂CF₂CF(CF₃)₂ |
| | pentadecafluoro-8- | |
| | (trifluoromethyl)non-4-ene | |
| F35tE | 1,1,1,2,2,3,3,7,7,8,8,8-dodecafluoro- | C₂F₅CF₂CH═CH—C(CF₃)₂C₂F₅ |
| | 6,6-bis(trifluoromethyl)oct-4-ene | |
| F3i5E | 1,1,1,2,5,5,6,6,7,7,8,8,9,9,9- | (CF₃)2CFCH═CH—(CF₂)₄CF₃ |
| | pentadecafluoro-2- | |
| | (trifluoromethyl)non-3-ene | |
| F3i5iE | 1,1,1,2,5,5,6,6,7,8,8,8-dodecafluoro- | (CF₃)₂CFCH═CH—CF₂CF₂CF(CF₃)₂ |
| | 2,7-bis(trifluoromethyl)oct-3-ene | |
| F3i5tE | 1,1,1,2,6,6,7,7,7-nonafluoro-2,5,5- | (CF₃)₂CFCH═CH—C(CF₃)₂C₂F₅ |
| | tris(trifluoromethyl)hept-3-ene | |
| F44iE | 1,1,1,2,3,3,6,6,7,7,8,8,9,9,9- | CF₃(CF₂)₃CH═CH—CF₂CF(CF₃)₂ |
| | pentadecafluoro-2- | |
| | (trifluoromethyl)non-4-ene | |
| F44sE | 1,1,1,2,2,3,6,6,7,7,8,8,9,9,9- | CF₃(CF₂)₃CH═CH—CF(CF₃)C₂F₅ |
| | pentadecafluoro-3- | |
| | (trifluoromethyl)non-4-ene | |
| F44tE | 1,1,1,5,5,6,6,7,7,8,8,8-dodecafluoro- | CF₃(CF₂)₃CH═CH—C(CF₃)₃ |
| | 2,2,-bis(trifluoromethyl)oct-3-ene | |
| F4i4iE | 1,1,1,2,3,3,6,6,7,8,8,8-dodecafluoro- | (CF₃)₂CFCF₂CH═CH—CF₂CF(CF₃)₂ |
| | 2,7-bis(trifluoromethyl)oct-4-ene | |
| F4i4sE | 1,1,1,2,3,3,6,7,7,8,8,8-dodecafluoro- | (CF₃)₂CFCF₂CH═CH—CF(CF₃)C₂F₅ |
| | 2,6-bis(trifluoromethyl)oct-4-ene | |
| F4i4tE | 1,1,1,5,5,6,7,7,7-nonafluoro-2,2,6- | (CF₃)₂CFCF₂CH═CH—C(CF₃)₃ |
| | tris(trifluoromethyl)hept-3-ene | |
| F4s4sE | 1,1,1,2,2,3,6,7,7,8,8,8-dodecafluoro- | C₂F₅CF(CF₃)CH═CH—CF(CF₃)C₂F₅ |
| | 3,6-bis(trifluoromethyl)oct-4-ene | |
| F4s4tE | 1,1,1,5,6,6,7,7,7-nonafluoro-2,2,5- | C₂F₅CF(CF₃)CH═CH—C(CF₃)₃ |
| | tris(trifluoromethyl)hept-3-ene | |
| F4t4tE | 1,1,1,6,6,6-hexafluoro-2,2,5,5- | (CF₃)₃CCH═CH—C(CF₃)₃ |
| | tetrakis(trifluoromethyl)hex-3-ene | |

TABLE 4

| Acronyms | Chemical Composition | Structure |
|---|---|---|
| SF10 | methyl perfluoroheptene ethers | |
| | (isomeric mixture) (MPHE) | |
| SF79 | 94% trans-1,2-dichloroethylene | (E)-ClCH═CHCl |
| | 5% MPHE | |
| | 1% Vertrel XF (1,1,1,2,3,4,4,5,5,5- | CF3CF2CFHCFHCF3 |
| | decafluoropentane) | |
| SF80 | 94% trans-1,2-dichloroethylene | (E)-ClCH═CHCl |
| | 5% MPHE | |
| | 1% Z-1336mzz | (Z)-CF3CH═CHCF3 |
| SF01 | 98.4% Z-1336mzz | (Z)-CF3CH═CHCF3 |
| | 1.6% ethanol | CH3CH2OH |
| SF05 | 60% Z-1336mzz | (Z)-CF3CH═CHCF3 |
| | 25% MPHE | |
| | 15% ethanol | CH3CH2OH |
| SF30 | 75% Z-1336mzz | (Z)-CF3CH═CHCF3 |
| | 25% trans-1,2-dichloroethylene | (E)-ClCH═CHCl |
| SF33 | (Z)-1,1,1,4,4,4-hexafluoro-2-butene | (Z)-CF3CH═CHCF3 |

Also disclosed herein are methods for and compositionally rebalanced and optionally stabilized compositions including, but not limited to blends of at least one of HFO-E-1336mzz, HFO-Z-1336mzz, HFO-Z/E 1336mzz, HCFO-E-1224 yd, HCFO-E-1233zd, HCFO-Z-1233zd, and HCFO-Z-1224 yd from treatment using the disclosed reclamation process. A stabilizer package includes at least one of an antioxidant, acid acceptor and metal stabilizer where the antioxidant is selected from butylated hydroxytoluene, butylated hydroxyanisole, tertiary-butylhydroquinone, 4-methoxyphenol, propyl 3,4,5-trihydroxybenzoate, the acid acceptor is selected from epoxy butane, amine, and acetaldehyde di-methylhydrazone (ADH) and the metal stabilizer is selected from N,N′-bis(salicylidene)-1,2-propanediamine, benzotriazole and its derivatives.

Disclosed herein are integrated systems and methods for refrigerant reclamation including, but not limited to, HFO-E-1336mzz, HFO-Z-1336mzz, HFO-Z/E 1336mzz, HCFO-Z-1224 yd, HCFO-E-1233zd, R-514A; HFO-E-1336mzz, HFO-Z-1336mzz, HCFO-1233zd, and HCFO-1224 yd components and blends.

Disclosed herein are integrated systems and methods for reclaiming liquid blend blowing agents including but not limited to at least one of E-1336mzz, Z-1336mzz, E-1233zd, and Z-1224 yd.

Disclosed herein are integrated systems and methods for solvent and immersion cooling liquid reclamation including, but not limited to Vertrel™ specialty fluids such as Vertrel XF; Opteon™ specialty fluids such as SF10, SF30, SF33, CFX-70, SF79, SF80, SF01, SF05; 3M hydrofluoroethers such as Novec 7100, Novec 7200, Novec 7300, Novec 7500, Novec 649, Novec 71DE, Novec 71DA, Novec 72DA, Novec 72DE, Novec 71IPA, Novec 73DE; and Microcare MCF.

Disclosed herein are integrated systems and methods for converting foam waste into reusable polymer and distillable halogenated vapor for purification.

In one embodiment disclosed herein the spent halogenated liquids, including but not limited to liquid refrigerants, refrigerant blends, liquid blowing agents, solvents, and/or immersion coolants are collected, assessed and treated to remove at least one of acidity, oil, particulates/solids, stabilizer, and spent stabilizer, and moisture, and separated, and optionally compositionally rebalanced to produce high purity, industry compliant halogenated liquid components and blends for reuse as refrigerants, liquid blowing agents, solvents, and/or immersion coolants (fluids).

In a still further embodiment disclosed herein one or more unreclaimed (spent) chlorofluoroolefin (CFO), hydrochloroolefin (HCO), hydrofluoroolefin (HFO), hydrochlorofluoroolefin (HCFO), hydrofluoroether (HFE), hydrofluoroolefinic ether (HFOE), hydrofluoroketone (HFK), fluoroketone (FK) liquids are reclaimed to produce high purity components and blends.

In a further embodiment disclosed herein, hydrofluoroolefin (HFO) liquids and/or hydrochlorofluoroolefin (HCFO) liquids are reclaimed.

In a still further embodiment disclosed herein, hydrofluoroether (HFE) liquids are reclaimed.

In a still further embodiment disclosed herein, mixtures of one or more unreclaimed (spent) hydrofluoroolefin (HFO) liquids and/or hydrochlorofluoroolefin (HCFO) liquids and hydrofluoroether (HFE) liquids are reclaimed to produce high purity HFO, HCFO and HFE components and blends.

In a still further embodiment disclosed herein mixtures of one or more unreclaimed (spent) chlorofluoroolefin (CFO) liquids, hydrochloroolefin liquids (HCO) hydrofluoroolefin (HFO) liquids, hydrochlorofluoroolefin (HCFO) liquids, hydrofluoroether (HFE) liquids, fluoroketone (FK) and hydrofluoroketone (HFK) liquids are reclaimed to produce high purity CFO, CHO, HFO, HCFO, HFE and HFK components and blends.

In another embodiment disclosed herein, refrigerant liquids are reclaimed.

In another embodiment disclosed herein, solvents are reclaimed.

In another embodiment disclosed herein, immersion coolants are reclaimed.

In other embodiments herein, one of more of the compounds identified in Table 1 are reclaimed.

In other embodiments herein, one of more of the compounds identified in Table 2 are reclaimed.

In other embodiments herein, one of more of the compounds identified in Table 3 are reclaimed.

In other embodiments herein, one of more of the compounds identified in Table 4 are reclaimed.

In another embodiment disclosed herein, any of the reclaimed compositions disclosed herein are packaged in containers constructed of any suitable material and design that is capable of sealing the compositions. Examples of suitable containers comprise pressure resistant containers such as a tank, a filling cylinder, and a secondary filing cylinder. The container can be constructed from any suitable material such as carbon steel, manganese steel, chromium-molybdenum steel, among other low-alloy steels, stainless steel and in some case an aluminum alloy. Refrigerant containing compositions stored in these containers can be transferred to a heat transfer system and, in turn, used as a working fluid.

In another embodiment of the invention, spent foam wastes are collected, and crushed to form processible solids and release trapped vapors. The crushed solids are pelletized and the vapors collected, separated and purified into reusable components and compositions.

In one embodiment of the invention, one or more molecular sieves beds are used to remove water from the halogenated liquid, e.g., refrigerant, solvent, blowing agent and immersion fluid, e.g., water above or below its saturation point (greater than 350 ppm).

In another embodiment of the invention, unsolubilized water above its saturation point is removed from the refrigerant, solvent, blowing agent, trapped vapor and immersion fluid using distillation or decanting.

In still further embodiments of the invention, refrigerant blends, solvent blends, immersion fluids, and/or commercial blends are purified and, for example: separated into its components, such as R-514A into dichloroethylene (DCE) and Z-1336mzz.

Disclosed herein are systems, methods and additives to stabilize refrigerants, refrigerant blends, liquid blowing agents, solvents, electronic immersion fluids where the stabilizer and/or stabilizer package includes, but is not limited to, an antioxidant selected from butylated hydroxytoluene (BHT), butylated hydroxyanisole (BHA), tertiary-butylhydroquinone, 4-methoxyphenol, propyl 3,4,5-trihydroxybenzoate), an acid acceptor (epoxy butane, amine, and acetaldehyde di-methylhydrazone (ADH)), and optionally a metal stabilizer (N,N′-bis(salicylidene)-1,2-propanediamine, benzotriazole and its derivatives).

### BRIEF DESCRIPTION OF THE DRAWINGS

FIG. 1 illustrates a method and system for reclaiming unreclaimed halogenated liquids according to an embodiment of the present invention.

FIG. 2 illustrates a method and system for foam waste reclamation according to an embodiment of the present invention.

FIG. 3 illustrates a method and system for foam waste reclamation according to another embodiment of the present invention.

FIG. 4 illustrates one embodiment of the present invention.

FIG. 5 illustrates system for purifying unreclaimed (non-purified) refrigerant liquids

FIG. 6 illustrates a service center system.

### DETAILED DESCRIPTION

The present invention is directed to integrated reclamation methods which treat and convert spent, e.g., used, contaminated, halogenated liquids and foam waste into high purity liquids, compositions and solids which meet industry standards for reuse and recycling. Properties of the spent halogenated liquids can be assessed, and physical/chemical treatments selected to clean up the spent halogenated liquids to remove e.g., contaminants, moisture, water, acidity, gases, e.g., air, oil, particulates/solids, stabilizers, etc. For levels of unsolubilized water above the saturation point, distillation or decanting may also be used. Moisture removal can involve the use of molecular sieves, decanting. Distillation can be used to separate and/or purify liquids and liquid components of the spent halogenated liquids, for example separate R-514A, into dichloroethylene (R-1130) and 1,1,1,4,4,4-hexafluorobut-2-ene (Z-1336mzz).

In some embodiments, the reclaimed halogenated liquids may be reused in a wide variety of applications as substitutes for CFCs and for compositions containing less desirable HCFCs. For example, the present reclaimed halogenated liquids are useful as blowing agents, refrigerants, heating agents, power cycle agents, immersion coolants and cleaning agents. In some embodiments, the reclaimed halogenated liquids disclosed herein are packaged in containers constructed of any suitable material and design that are capable of sealing the liquid and/or liquid compositions. Examples of suitable containers comprise pressure resistant containers such as a tank, a filling cylinder, and a secondary filing cylinder. The container can be constructed from any suitable material such as carbon steel, manganese steel, chromium-molybdenum steel, among other low-alloy steels, stainless steel and in some case an aluminum alloy. Refrigerant-containing compositions stored in these containers can be transferred to a heat transfer system and, in turn, used as a working fluid.

In some embodiments disclosed herein, the liquid refrigerants, liquid blowing agents, solvent and/or immersion coolants (dielectric compatible heat transfer medium for electronics) to be reclaimed are selected from at least one hydrofluoroolefin (HFO), hydrochlorofluoroolefin (HCFO), hydrofluoroether (HFE), fluoropolyethers (PFPEs, HFPEs) or hydrofluoroolefinic ether (HFOE), and hydrofluorocarbons (HFCs).

In some embodiments disclosed herein, the liquid refrigerant and/or liquid heat transfer medium does not undergo a phase change and can be used in a coolant circuit to remove/transfer heat from power systems, vehicles, an exhaust system of a vehicle, an internal combustion engine (ICE).

Hydrofluoroethers (HFEs) are compounds containing carbon, hydrogen and fluorine and also containing ether linkages. Hydrofluoroolefins (HFOs) are compounds containing carbon, hydrogen and fluorine and also containing double bonds. Hydrofluoroolefins (HCFO) are compounds containing carbon, hydrogen, fluorine and also a double bond.

As used herein, ODP is defined in the “Scientific Assessment of Ozone Depletion, 2002,” a report of the World Meteorological association, incorporated here by reference. As used herein, GWP is defined relative to that of carbon dioxide and over a 100-year time horizon and defined in the same reference as for the ODP mentioned above.

As used herein, a refrigerant is a compound or mixture of compounds used as working fluid used to carry heat from a heat source to a heat sink. Such heat transfer compositions may also be useful as a refrigerant in a cycle wherein the fluid undergoes a phase change; that is, from a liquid to a gas and back, or vice versa. Examples of heat transfer systems include but are not limited to air conditioners, freezers, refrigerators, heat pumps, water chillers, flooded evaporator chillers, direct expansion chillers, walk-in coolers, high temperature heat pumps, mobile refrigerators, mobile air conditioning units, electric storage cooling systems, battery cooling, immersion cooling systems, data-center cooling systems, and combinations thereof.

As used herein, immersion cooling is used to cool electronic devices, such as datacenter servers, insulated-gate bipolar transistor (IGBT) devices, telecommunication infrastructure, military electronics, televisions (TVs), cell phones, monitors, drones, automotive batteries, powertrains for electric vehicles (EVs), avionics devices, power devices and displays. Immersion cooling systems are heat transfer devices wherein there is no compressor, and the heat transfer medium possesses suitable dielectric properties. Generally, the object to be cooled is at least partially immersed in (in direct contact with) the heat transfer fluid contained in a vessel. In some embodiments, the heat transfer fluid may evaporate and condense in the vessel. In other embodiments, there may be no phase transition involved.

Provided herein are integrated methods to reclaim foam wastes, including but not limited to closed cell, polyurethane foam. As is known to those skilled in the art, foam wastes are formed from compositions which generally include one or more components capable of forming foams and blowing agents. In some embodiments, the blowing agent compound is at least one of E-1336mzz, Z-1336mzz, E-1233zd, and Z-1224 yd.

As use herein, a refrigerant is a compound or mixture of compounds (blend) that function as a heat transfer fluid in a cycle wherein the fluid undergoes a phase change from a liquid to a gas and back.

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method that includes materials, steps, features, components, or elements, in addition to those literally disclosed provided that these additional included materials, steps, features, components, or elements do not materially affect the basic and novel characteristic(s) of the claimed invention, especially the mode of action to achieve the desired result of any of the processes of the present invention. The term “consisting essentially of” occupies a middle ground between “comprising” and “consisting of.”

Where applicants have defined an invention or a portion thereof with an open-ended term such as “comprising,” it should be readily understood that (unless otherwise stated) the description should be interpreted to also include such an invention using the terms “consisting essentially of” or “consisting of.”

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless defined otherwise, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

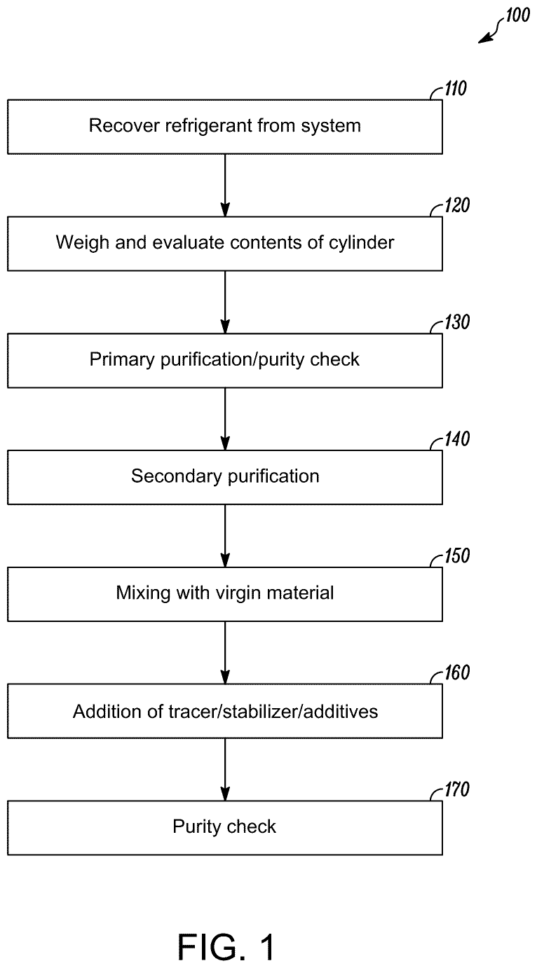

In FIG. 1, 100 illustrates a non-limiting example of the process and system for reclaiming halogenated liquids and/or vapors according to the invention. Unreclaimed liquids are recovered using system 110.

In one embodiment, the unreclaimed (spent) liquids include hydrofluoroolefins (HFOs), hydrochlorofluoroolefins (HCFO), hydrofluoroethers (HFEs) and mixtures and blends, in particular at least one of E-1336mzz, Z-1336mzz, E-1233zd, and Z-1224 yd and R-514A.

In another embodiment, the unreclaimed (spent) liquids are fluoro- and perfluoro-butanes, pentanes, hexanes, heptanes, and octanes including, but not limited to, 1,1,1,2,2,3,3,4,4,5,5,6,6-tridecafluorooctane, 1,1,1,2,2,3,4,5,5,5-decafluoropentane, 1,1,1,3,3-pentafluorobutane, 1,1,2,2,3,3,4-heptafluorocyclopentane and tridecafluorooctane.

In a still further embodiment, the unreclaimed (spent) liquids include fluorinated and perfluorinated C₄-C₇ unsaturated compounds, such as 1, 1, 1,2,3,4,4,4-octafluoro-2-butene (CF₃CF═CFCF₃); 1,1,2,3,3,4,4,4-octafluoro-1-butene (CF₃CF₂CF═CF₂); 1,1,1,2,4,4,4-heptafluoro-2-butene (CF₃CF═CHCF₃); 1,2,3,3,4,4,4-heptafluoro-1-butene (CHF═CFCF₂CF₃); 1,1,1,2,3,4,4-heptafluoro-2-butene (CHF₂CF═CFCF₃); 1,3,3,3-tetrafluoro-2-(trifluoromethyl)-1-propene ((CF₃)₂C═CHF); 1,1,3,3,4,4,4-heptafluoro-1-butene (CF₂-CHCF₂CF₃); 1,1,2,3,4,4,4-heptafluoro-1-butene (CF₂-CFCHFCF₃); 1, 1,2,3,3,4,4-heptafluoro-1-butene (CF₂-CFCF₂CHF₂); 2,3,3,4,4,4-hexafluoro-1-butene (CF₃CF₂CF-CH₂); 1,3,3,4,4,4-hexafluoro-1-butene (CHF═CHCF₂CF₃); 1,2,3,4,4,4-hexafluoro-1-butene (CHF═CFCHFCF₃); 1,2,3,3,4,4-hexafluoro-1-butene (CHF═CFCF₂CHF₂); 1, 1,2,3,4,4-hexafluoro-2-butene (CHF₂CF═CFCHF₂); 1,1,1,2,3,4-hexafluoro-2-butene (CH₂FCF═CFCF₃); 1,1,1,2,4,4-hexafluoro-2-butene (CHF₂CH═CFCF₃); 1, 1, 1,3,4,4-hexafluoro-2-butene (CF₃CH═CFCHF₂); 1,1,2,3,3,4-hexafluoro-1-butene (CF₂═CFCF₂CH₂F); 1,1,2,3,4,4-hexafluoro-1-butene (CF₂═CFCHFCHF₂); 3,3,3-trifluoro-2-(trifluoromethyl)-1-propene (CH₂═C(CF₃)₂); 1,1,1,2,4-pentafluoro-2-butene (CH₂FCH═CFCF₃); 1,1, 1,3,4-pentafluoro-2-butene (CF₃CH═CFCH₂F); 3,3,4,4,4-pentafluoro-1-butene (CF₃CF₂CH═CH₂); 1,1,1,4,4-pentafluoro-2-butene (CHF₂CH—CHCF₃); 1,1,1,2,3-pentafluoro-2-butene (CH₃CF═CFCF₃); 2,3,3,4,4-pentafluoro-1-butene (CH₂═CFCF₂CHF₂); 1,1,2,4,4-pentafluoro-2-butene (CHF₂CF═CHCHF₂); 1,1,2,3,3-pentafluoro-1-butene (CH₃CF₂CF═CF₂); 1, 1,2,3,4-pentafluoro-2-butene (CH₂FCF═CFCHF₂); 1,1,3,3,3-pentafluoro-2-methyl-1-propene (CF₂═C(CF₃)(CH₃)); 2-(difluoromethyl)-3,3,3-trifluoro-1-propene (CH₂═C(CHF₂)(CF₃)); 2,3,4,4,4-pentafluoro-1-butene (CH₂═CFCHFCF₃); 1,2,4,4,4-pentafluoro-1-butene (CHF═CFCH₂CF₃); 1,3,4,4,4-pentafluoro-1-butene (CHF═CHCHFCF₃); 1,3,3,4,4-pentafluoro-1-butene (CHF═CHCF₂CHF₂); 1,2,3,4,4-pentafluoro-1-butene (CHF═CFCHFCHF₂); 3,3,4,4-tetrafluoro-1-butene (CH₂-CHCF₂CHF₂); 1, 1-difluoro-2-(difluoromethyl)-1-propene (CF₂═C(CHF₂)(CH₃)); 1,3,3,3-tetrafluoro-2-methyl-1-propene (CHF═C(CF₃)(CH₃)); 3,3-difluoro-2-(difluoromethyl)-1-propene (CH₂═C(CHF₂)₂); 1,1,1,2-tetrafluoro-2-butene (CF₃CF═CHCH₃); 1,1, 1,3-tetrafluoro-2-butene (CH₃CF═CHCF₃); 1,1, 1,2,3,4,4,5,5,5-decafluoro-2-pentene (CF₃CF═CFCF₂CF₃); 1,1,2,3,3,4,4,5,5,5-decafluoro-1-pentene (CF₂═CFCF₂CF₂CF₃); 1,1,1,4,4,4-hexafluoro-2-(trifluoromethyl)-2-butene ((CF₃)₂C═CHCF₃); 1,1,1,2,4,4,5,5,5-nonafluoro-2-pentene (CF₃CF-CHCF₂CF₃); 1,1,1,3,4,4,5,5,5-nonafluoro-2-pentene (CF₃CH═CFCF₂CF₃); 1,2,3,3,4,4,5,5,5-nonafluoro-1-pentene (CHF═CFCF₂CF₂CF₃); 1,1,3,3,4,4,5,5,5-nonafluoro-1-pentene (CF₂-CHCF₂CF₂CF₃); 1,1,2,3,3,4,4,5,5-nonafluoro-1-pentene (CF₂-CFCF₂CF₂CHF₂); 1,1,2,3,4,4,5,5,5-nonafluoro-2-pentene (CHF₂CF═CFCF₂CF₃); 1,1,1,2,3,4,4,5,5-nonafluoro-2-pentene (CF₃CF═CFCF₂CHF₂); 1,1,1,2,3,4,5,5,5-nonafluoro-2-pentene (CF₃CF═CFCHFCF₃); 1,2,3,4,4,4-hexafluoro-3-(trifluoromethyl)-1-butene (CHF═CFCF(CF₃)₂); 1,1,2,4,4,4-hexafluoro-3-(trifluoromethyl)-1-butene (CF₂-CFCH(CF₃)₂); 1,1,1,4,4,4-hexafluoro-2-(trifluoromethyl)-2-butene (CF₃CH═C(CF₃)₂); 1,1,3,4,4,4-hexafluoro-3-(trifluoromethyl)-1-butene (CF₂═CHCF(CF₃)₂); 2,3,3,4,4,5,5,5-octafluoro-1-pentene (CH₂═CFCF₂CF₂CF₃); 1,2,3,3,4,4,5,5-octafluoro-1-pentene (CHF═CFCF₂CF₂CHF₂); 3,3,4,4,4-pentafluoro-2-(trifluoromethyl)-1-butene (CH₂-C(CF₃)CF₂CF₃); 1,1,4,4,4-pentafluoro-3-(trifluoromethyl)-1-butene (CF₂═CHCH(CF₃)₂); 1,3,4,4,4-pentafluoro-3-(trifluoromethyl)-1-butene (CHF═CHCF(CF₃)₂); 1,1,4,4,4-pentafluoro-2-(trifluoromethyl)-1-butene (CF₂-C(CF₃) CH₂CF₃); 3,4,4,4-tetrafluoro-3-(trifluoromethyl)-1-butene ((CF₃)₂CFCH—CH₂); 3,3,4,4,5,5,5-heptafluoro-1-pentene (CF₃CF₂CF₂CH—CH₂); 2,3,3,4,4,5,5-heptafluoro-1-pentene (CH₂═CFCF₂CF₂CHF₂); 1, 1,3,3,5,5,5-heptafluoro-1-butene (CF₂-CHCF₂CH₂CF₃); 1,1,1,2,4,4,4-heptafluoro-3-methyl-2-butene (CF₃CF═C(CF₃)(CH₃)); 2,4,4,4-tetrafluoro-3-(trifluoromethyl)-1-butene (CH₂-CFCH(CF₃)₂); 1,4,4,4-tetrafluoro-3-(trifluoromethyl)-1-butene (CHF═CHCH(CF₃)₂); 1, 1, 1,4-tetrafluoro-2-(trifluoromethyl)-2-butene (CH₂FCH═C(CF₃)₂); 1,1,1,3-tetrafluoro-2-(trifluoromethyl)-2-butene (CH₃CF-C(CF₃)₂); 1,1,1-trifluoro-2-(trifluoromethyl)-2-butene ((CF₃)₂C═CHCH₃); 3,4,4,5,5,5-hexafluoro-2-pentene (CF₃CF₂CF═CHCH₃); 1,1, 1,4,4,4-hexafluoro-2-methyl-2-butene (CF₃C(CH₃)═CHCF₃); 3,3,4,5,5,5-hexafluoro-1-pentene (CH₂═CHCF₂CHFCF₃); 4,4,4-trifluoro-2-(trifluoromethyl)-1-butene (CH₂-C(CF₃) CH₂CF₃); 1,1,2,3,3,4,4,5,5,6,6,6-dodecafluoro-1-hexene (CF₃(CF₂)₃CF-CF₂); 1,1,1,2,2,3,4,5,5,6,6,6-dodecafluoro-3-hexene (CF₃CF₂CF═CFCF₂CF₃); 1,1,1,4,4,4-hexafluoro-2,3-bis(trifluoromethyl)-2-butene ((CF₃)₂C-C(CF₃)₂); 1,1,1,2,3,4,5,5,5-nonafluoro-4-(trifluoromethyl)-2-pentene ((CF₃)₂CFCF═CFCF₃); 1,1,1,4,4,5,5,5-octafluoro-2-(trifluoromethyl)-2-pentene ((CF₃)₂C-CHC₂F₅); 1,1,1,3,4,5,5,5-octafluoro-4-(trifluoromethyl)-2-pentene ((CF₃)₂CFCF═CHCF₃); 3,3,4,4,5,5,6,6,6-nonafluoro-1-hexene (CF₃CF₂CF₂CF₂CH═CH₂); 4,4,4-trifluoro-3,3-bis(trifluoromethyl)-1-butene (CH₂═CHC(CF₃)₃); 1,1,1,4,4,4-hexafluoro-3-methyl-2-(trifluoromethyl)-2-butene ((CF₃)₂C-C(CH₃)(CF₃)); 2,3,3,5,5,5-hexafluoro-4-(trifluoromethyl)-1-pentene (CH₂-CFCF₂CH(CF₃)₂); 1,1,1,2,4,4,5,5,5-nonafluoro-3-methyl-2-pentene (CF₃CF═C(CH₃)CF₂CF₃); 1,1,1,5,5,5-hexafluoro-4-(trifluoromethyl)-2-pentene (CF₃CH═CHCH(CF₃)₂); 3,4,4,5,5,6,6,6-octafluoro-2-hexene (CF₃CF₂CF₂CF═CHCH₃); 3,3,4,4,5,5,6,6-octafluoro1-hexene (CH₂═CHCF₂CF₂CF₂CHF₂); 1,1,1,4,4-pentafluoro-2-(trifluoromethyl)-2-pentene ((CF₃)₂C═CHCF₂CH₃); 4,4,5,5,5-pentafluoro-2-(trifluoromethyl)-1-pentene (CH₂-C(CF₃) CH₂C₂F₅); 3,3,4,4,5,5,5-heptafluoro-2-methyl-1-pentene (CF₃CF₂CF₂C(CH₃)═CH₂); 4,4,5,5,6,6,6-heptafluoro-2-hexene (CF₃CF₂CF₂CH═CHCH₃); 4,4,5,5,6,6,6-heptafluoro-1-hexene (CH₂═CHCH₂CF₂C₂F₅); 1,1,1,2,2,3,4-heptafluoro-3-hexene (CF₃CF₂CF═CFC₂H₅); 4,5,5,5-tetrafluoro-4-(trifluoromethyl)-1-pentene (CH₂═CHCH₂CF(CF₃)₂); 1, 1,1,2,5,5,5-heptafluoro-4-methyl-2-pentene (CF₃CF═CHCH(CF₃)(CH₃)); 1,1,1,3-tetrafluoro-2-(trifluoromethyl)-2-pentene ((CF₃)₂C═CFC₂H₅); 1,1,1,2,3,4,4,5,5,6,6,7,7,7-tetradecafluoro-2-heptene (CF₃CF═CFCF₂CF₂C₂F₅); 1,1,1,2,2,3,4,5,5,6,6,7,7,7-tetradecafluoro-3-heptene (CF₃CF₂CF═CFCF₂C₂F₅); 1,1,1,3,4,4,5,5,6,6,7,7,7-tridecafluoro-2-heptene (CF₃CH—CFCF₂CF₂C₂F₅); 1,1,1,2,4,4,5,5,6,6,7,7,7-tridecafluoro-2-heptene (CF₃CF═CHCF₂CF₂C₂F₅); 1,1,1,2,2,4,5,5,6,6,7,7,7-tridecafluoro-3-heptene (CF₃CF₂CH═CFCF₂C₂F₅); 1, 1,1,2,2,3,5,5,6,6,7,7,7-tridecafluoro-3-heptene (CF₃CF₂CF═CHCF₂C₂F₅) alone, or in admixture with other HFO, HCFO and HFC compounds.

In another embodiment, the unreclaimed (spent) solvent includes, but is not limited, to saturated or unsaturated compounds containing only carbon, fluorine, and hydrogen atoms, wherein the number of carbons is 4-10. Specific examples include tridecafluorooctane, decafluoropentane, pentafluorobutane, heptafluorocyclopentane, pentadecafluoroheptane, and hexafluorobutene.

In a still further embodiment, unreclaimed (spent) halogenated liquids, e.g., immersion coolants and solvents, include for example, Z-1,1,1,4,4,4-hexafluoro-2-butene, 1,3,4,4,4-pentafluoro-3-trifluoromethyl-1-butene, 1,1,1,4,4,5,5,5-octafluoro-2-pentene, perfluorobutyl methyl ether, perflurobutyl ethyl ether, perfluoroisopropylmethyl ether, perfluoroethyl isopropyl ketone, heptafluorocyclopentane, and E-1,1,1-trifluoro-3-chloro-2-propene, alone or in combination with the fluoroethers disclosed in U.S. Pat. No. 9,840,685 B2, the disclosure of which is incorporated herein by reference in its entirety, as well as combinations with methylperfluoroheptene ether (MPHE) and trans-1,2-dichloroethylene, or the compositions of U.S. Pat. No. 9,428,717B2, the disclosure of which is incorporated herein by reference in its entirety.

In a still further embodiment, the unreclaimed (spent) liquid can include any of the immersion cooling liquids disclosed in U.S. Patent Application Publication No. 2020/0178414, the disclosure of which is incorporated herein by reference in its entirety.

In a still further embodiment, the unreclaimed (spent) liquid can include any of the compounds of (a) formula CF₃(CF₂)ₓCF═CFCF(OR)(CF₂)_{y}CF₃, CF₃(CF₂)ₓC(OR)—CFCF₂(CF₂)_{y}CF₃, CF₃CF═CFCF(OR)(CF₂)ₓ(CF₂)_{y}CF₃, CF₃(CF₂)ₓCF═C(OR)CF₂(CF₂)_{y}CF₃, or mixtures thereof, wherein R can be either CH₃, C₂H₅ or mixtures thereof, and wherein x and y are independently 0, 1, 2 or 3, and wherein x+y=0, 1, 2 or 3; the compounds of (b) formulas CF₃(CF₂)ₓCF═CFCF(OR)(CF₂)_{y}CF₃, CF₃(CF₂)ₓC(OR)═CFCF₂(CF₂)_{y}CF₃, CF₃CF═CFCF(OR)(CF₂)ₓ(CF₂)_{y}CF₃, CF₃(CF₂)ₓCF═C(OR)CF₂(CF₂)_{y}CF₃, and mixtures thereof; wherein x and y are independently 0, 1, 2, 3 or 4 and wherein x+y=0, 1, 2, 3 or 4; and wherein R is 2,2,3,3-tetrafluoro-1-propyl, 2,2,3,3,3-pentafluoro-1-propyl, 2,2,2-trifluoro-1-ethyl, 2,2,3,3,4,4,5,5-octafluoro-1-pentyl, or 1, 1,1,3,3,3-hexafluoro-2-propyl; and (c) mixtures of compounds from (a) and (b), including but not limited to 5-methoxyperfluoro-3-heptene, 3-methoxyperfluoro-3-heptene, 4-methoxyperfluoro-2-heptene, 3-methoxyperfluoro-2-heptene, or mixtures thereof; at least one of 4-methoxyperfluoro-2-pentene, 2-methoxyperfluoro-2-pentene, 3-methoxyperfluoro-2-pentene, 2-methoxyperfluoro-3-pentene, or mixtures thereof; and at least one of cis- and trans-2-methoxyperfluoro-2-octene, 2-methoxyperfluoro-3-octene, or mixtures thereof, disclosed in U.S. Pat. No. 10,287,469B2, the disclosure of which is incorporated herein by reference in its entirety.

The amount and type of halogenated liquids to be reclaimed and described herein is transferred from the recovery/collection system 110 and liquid, where appropriate, is analyzed and its quantity determined in station or system 120 to detect and measure impurities, including but not limited to NAG (non-absorbable gases), acids, solids, water and/or high boiling residue content. The unreclaimed halogenated liquids, e.g., refrigerant, liquid blowing agent, solvent, immersion colling fluid, is analyzed using analytical techniques such as GC-FID, GC-TCD, GC-MS, FTIR, Goetz Bub, Karl Fischer, Byk-Garner Color and various other analytical methods to determine and optionally confirm the identity of the unreclaimed halogenated liquids. Generally organic product analysis involves gas-chromatography (GC/MS) or liquid chromatography.

The concentration of non-condensable gases (NCG) or non-absorbable gases (NAG) may vary or be altered, resulting in a concentration of less than 1.5 volume percent at 25° C., per AHRI 700, preferably below 0.9 volume percent at 25° C. per AHRI 700. NAG typically comprises air, (which is typically comprised of 78% nitrogen, 21% oxygen, and about 1% argon), accumulated in the vapor phase of refrigerants where the solubility of air in the liquid phase is extremely low. While reducing the total amount of NAG contained within liquid may be important, it is typically more desirable to reduce the oxygen containing portion of the NAG preferentially over the nitrogen portion. The oxygen containing portion, under certain scenarios, may increase the propensity of the certain olefins to decompose or form unwanted polymeric materials. NCG's may be detected using one of infrared sensors, UV sensors, NIR sensors, ion mobility or plasma chromatographs, gas chromatography, refractometry, mass spectroscopy, high temperature thick film sensors, thin film field effect sensors, pellistor sensors, Taguchi sensors and quartz microbalance sensors as disclosed in U.S. Patent 2008/0069177 incorporated herein by reference in its entirety.

The unreclaimed liquid component or composition, even if provided by a customer, may be analyzed as described above to assess the physical and chemical properties of the unreclaimed liquid composition and perform a purity check to see how it compares to the industry standard of AHRI-700. Based on the analytical (testing) results from the weighing and testing station, i.e., system 120, a first or primary purification will take place using a distillation column (adsorption/desorption and cryogenic cooling and/or other separations techniques) in system 130 and the first stage purified liquid reanalyzed and the purify rechecked. The first or primary purification system will optionally include column with absorbent/adsorbent to remove inhibitors and/or stabilizers in the unreclaimed liquid compositions disclosed herein. The column (not shown) may be upstream or downstream of the distillation component of system 130. When silica gel or other molecular sieve materials is used as the medium to remove the inhibitors and/or stabilizers, the unreclaimed liquid can be passed through the bed of silica gel and the inhibitor free ‘partially’ reclaimed product is transferred to one of more distillation columns to separate and isolate individual liquid components as the case may be. Thereafter, if the primary purification does not provide a treated product that is AHRI-700 compliant, it is transferred from system 130 to system 140 for further processing including targeted purification for NAG (purge stations), water (distillation/desiccant dryer), solids (filters), acidity (base bath), high boiling residue/chloride (distillation), and reanalyzed in the weighing and testing station, and purity rechecked to verify purity and industry compliance in system 140. The NAG reduction station (not shown) may contact the partially reclaimed liquid composition with a reducing agent, such as a metal powder, which may react with oxygen or other oxidizable components of the unreclaimed liquid composition. In one embodiment, the reducing agent may include iron powder. Treatment by the NAG reduction station may result in the concentration of one or more components of the partially reclaimed liquid composition being reduced to less than one or more predetermined thresholds.

Thereafter, in system 150 reclaimed liquid components from 130 or 140 are mixed with additional fresh/virgin/high purity liquid components to provide a reconstituted, compositionally rebalanced, and reclaimed liquid, e.g., refrigerant, solvent, immersion coolant, blowing agent, composition compliant with AHRI 700-19 standards in system 150. Tracers, stabilizers, and conventional additives are added in system 160, and then a final purity check is performed so that reclaimed and reconstituted liquid is AHRI 700-19 compliant. Each system 110, 120, 130, 140, 150 and 160 includes components for receiving and transferring liquid composition between upstream and downstream systems, such as flowlines, valves, pumps, controls, etc. (not shown).

In another embodiment, NAGs are separated from the refrigerant using a membrane which is placed such that the NAGs can pass through the membrane and are removed while the refrigerant does not pass through the membrane.

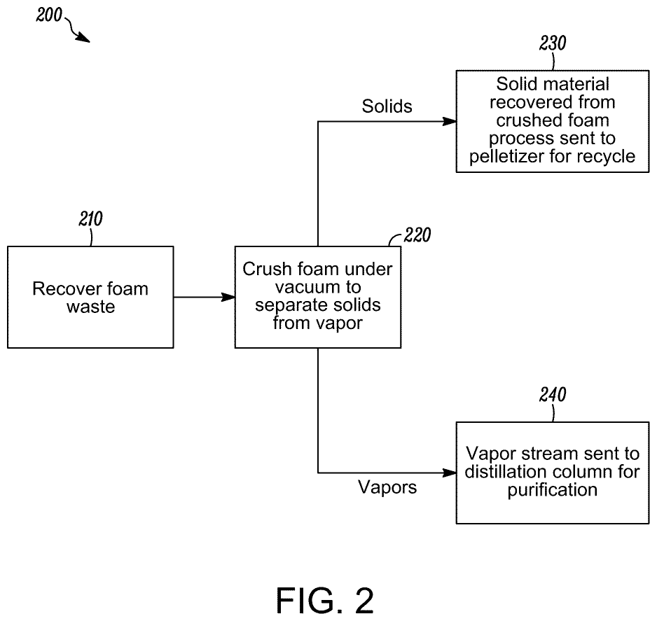

In FIG. 2, system 200 illustrates a non-limiting example of a system and method for foam waste reclamation. Foam waste, including but not limited to rigid polyurethane, is delivered, collected, sorted and weighed in recovery system 210, and then after sorting and weighing, transferred to treatment system 220 to physically reduce the dimensions of the foam waste into a suitable size by crushing or other technique. When the foam waste comprises a closed cell, rigid polyurethane foam, foam blowing agents and air remain within the cells. When the rigid foam is, crushed, pulverized, or shredded the blowing agent and air will be released. The blowing agent that is released includes but is not limited to combinations of HFC and/or HFO components selected from HFC-134a, HFC-245fa, HFC-365mfc, HFC-227ea, HCFO1233zd (E), HCFO-1224 yd (Z), HFO-1336mzz (E) and HFO-1336mzz (Z). Hydrocarbons may also be included such as (cyclopentane, isopentane, normal pentane. Generally, the released cell gas will be comprised of between 50 to 99.5 vol % air, and the balance the HFC and/or HFO. The concentration could vary due to the amount of blowing agent used to create the foam, the amount lost to atmosphere during the life of the foam, the amount of air that infiltrates the foam during the life of the foam, as well as the amount of air introduced during reclaiming and/or recycling process, and the efficiency of the foam pulverization.

As the treatment zone is typically operated under reduced pressure a vapor stream is formed and sent to one of the purification systems 130 and/or 140 from system 240, or a dedicated distillation system (not shown). Preferably, the cell gas composition would be known, prior to processing, as recovering the blowing agent would be a simpler process for neat HFC or HFO/air mixtures. However, as the integrated reclamation systems include testing stations for identifying components of products to be reclaimed, the vapor removed during crushing can be analyzed before purification. Crushed and/or pelletized foam waste from system 220 is collected and stored.

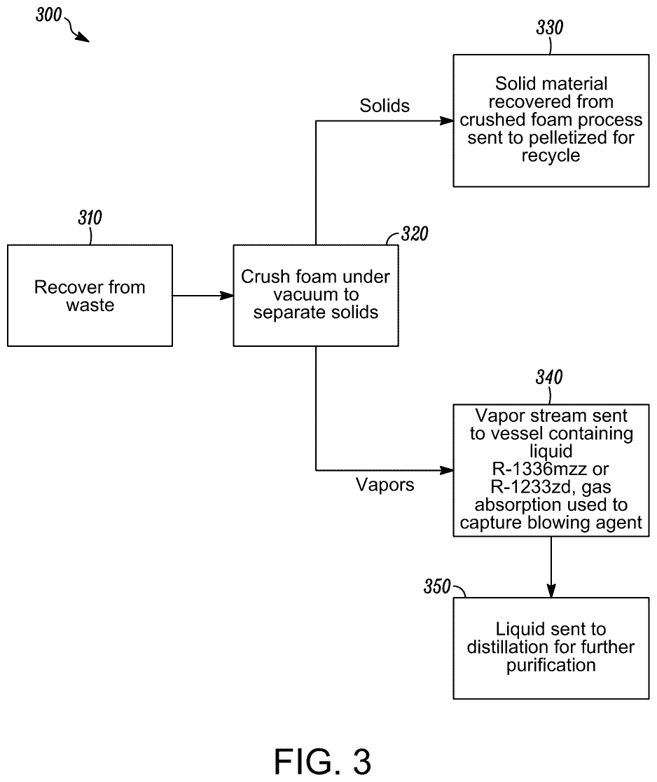

In FIG. 3, foam waste is sent through a process under vacuum (partial or total) where the foam would be crushed and pulverized under vacuum, and the vapor stream sent to a distillation process for liquid recovery. Solids are sent to a pelletizer for subsequent recycle. Once the foam is pulverized, the remaining solid portion is no longer a foam, it is polyurethane solids. These solids can be recovered, pelletized, or compressed and incinerated for fuel value, used as a concrete filler, or it is possible to recycled by glycolysis to chemically reduce the solids to a liquid polyol, which can be used again to make another polyurethane foam.

Since the crushing process is conducted under vacuum, excess air is minimized, and the distillation would primarily separate CO₂, 1336mzzZ/E, 1233zdE, 1224ydZ and/or air. The vapor stream from a pulverizer is sent to a vessel containing a liquid (e.g., 1336mzzZ or 1233zdE). By bubbling the vapor through the liquid, gas absorption is able to capture the blowing agent, which is then sent to distillation operations of systems 130 or 140 for purification.

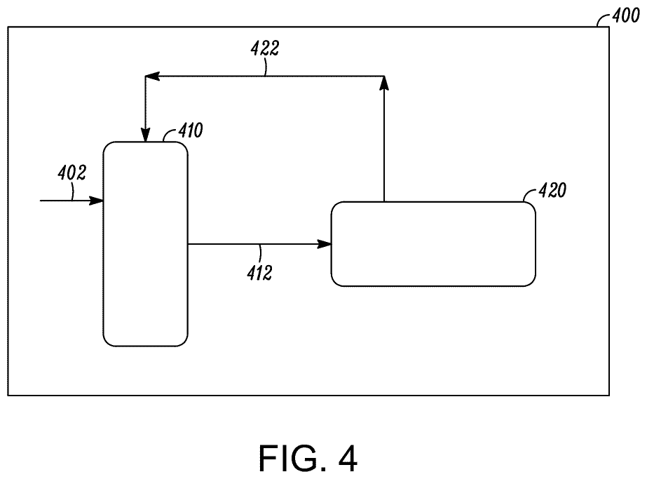

FIG. 4 illustrates a non-limiting example of a service center 400 including one or more systems 110, 120, 130, 140, 150 and 160 which can be connected to a mobile transport vehicle 420 to charge reclaimed refrigerant/refrigerant blends from system 410 through line 412, or recharge a refrigerant or refrigerant blend through line 412 which has been processed in system 410, and optionally withdraw spent refrigerant through line 422 from vehicle 420 for processing in system 410.

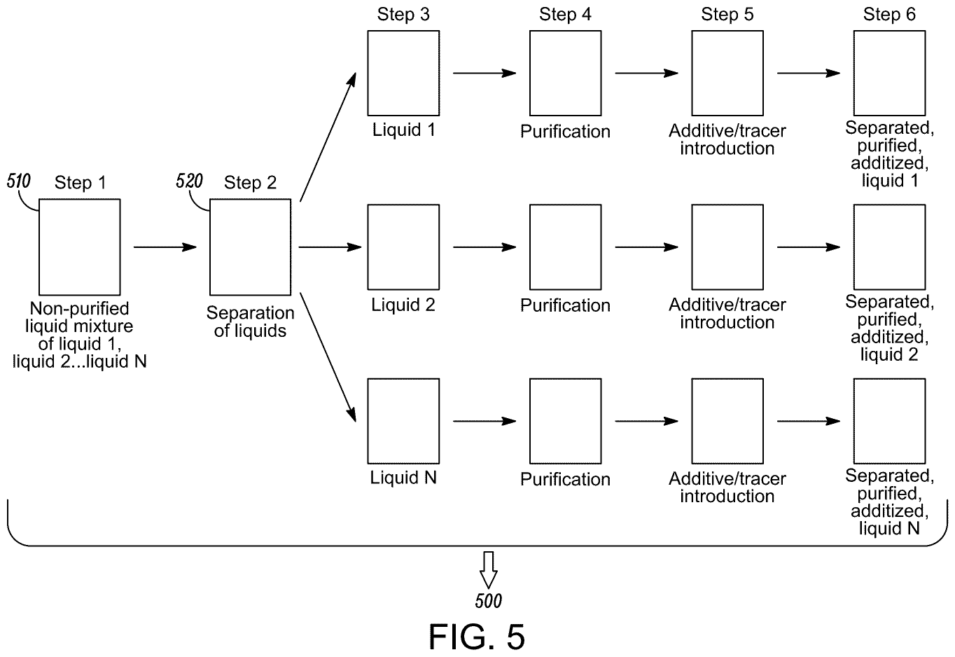

FIG. 5 illustrates system 500 for purifying unreclaimed (non-purified) refrigerant liquids from a mixture of N number of chemically distinct liquids collected in Step 1, unit 510, which contains unpurified liquid mixtures Liquid 1, Liquid 2 . . . liquid N. In Step 2: liquid components of liquid mixtures are separated via a separation process such as distillation. In Step 3: non purified separated liquids could require further processing, e.g., additional distillation removal of NAGs, etc. In Step 4: the purified liquid components of Step 4 are compared with industry quality standards, and involve removal of moisture, solids, volatile impurities. In Step 5: additive and/or tracers components are introduced to each purified individual component. In Step 6: separated, purified, addivized components can be remixed into other blends or used as pure components.

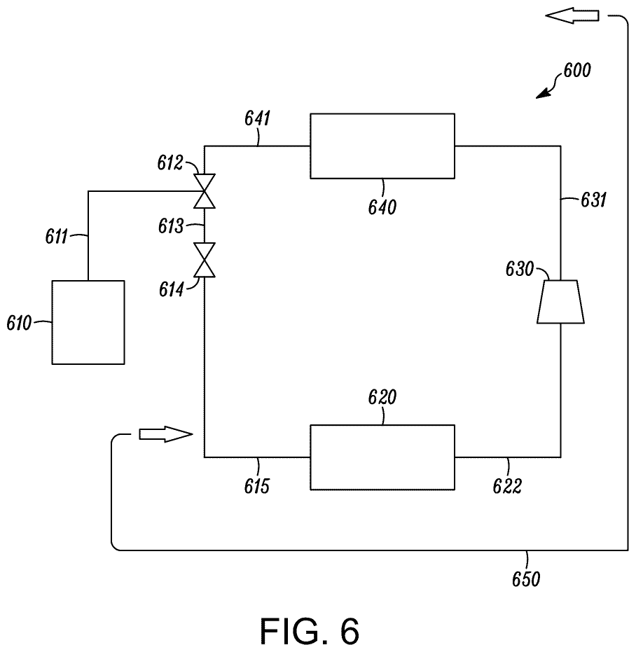

FIG. 6 illustrates a service center system 600 where a source of reclaimed/re-blended refrigerant 610 from a system such as that illustrated in FIG. 5 is connected to a refrigerant circuit 650 of a transport vehicle (not shown) which includes, generally in seriatim, charging valve 612, expansion device 614, heat exchange 620, compressor 630, heat exchange 640 and flow lines 613, 615, 622, 631 and 641. Reclaimed/re-blended refrigerant 610 is charged via line 611 which is in fluid communication with charging valve 612, which when opened charges refrigerant circuit 650.

One embodiment disclosed herein comprises a system with a contained supply of reclaimed/re-blended refrigerant, a refrigerant circuit including at least a charging valve and compressor, and a transfer line controllable connected said contained supply of reclaimed/re-blended refrigerant to a charging valve of the circuit. Another embodiment disclosed herein comprises a purification system, a contained supply of purified refrigerant receiving product from the purification system, and a refrigerant circuit including at least a charging valve and compressor, and transfer line controllable connected to said contained supply of reclaimed/re-blended refrigerant to said charging valve.

### Additional Embodiments

A process embodiment of a) treating foam waste and/or spent halogenated liquids to produce reclaimed foam polymer or reclaimed halogenated liquids, wherein the foam waste or spent halogenated liquids is selected from one of refrigerants and refrigerant blends, blowing agents, solvent, and immersion coolants, and b) collecting or packaging halogenated liquids components and foam waste. Prior to step a) the waste or spent halogenated liquids are recovered from various sources, such as systems circulating heat transfer liquid, storage facilities, discarded sources of refrigerants.

A process embodiment where the spent halogenated liquids of a) are treated and comprise at least one of chlorofluoroolefin (CFO), hydrochloroolefin (HCO), hydrofluoroolefin (HFO), hydrochlorofluoroolefin (HCFO), hydrofluoroether (HFE), hydrofluoroolefinic ether (HFOE), hydrofluoroketone (HFK), fluoroketone (FK) or where a) is foam waste is treated by crushing.

A process embodiment where the foam waste and/or spent halogenated liquids of a) are: (i) collected from unreclaimed foam waste or unreclaimed halogenated liquids prior to the treating in a).

A process embodiment where the unreclaimed halogenated liquids of a) are analyzed to determine the composition of the unreclaimed halogenated liquids and the presence and nature of any contaminants prior to a).

A process embodiment where physical and chemical properties of the unreclaimed halogenated liquids is determined prior to a).

A process embodiment where the treating of a) comprises physical and chemical treatments.

A process embodiment where the treating of a) comprises at least one of moisture removal, contaminant removal and distillation.

A process embodiment including at least one of a1) an unreclaimed halogenated liquids selected from chlorofluoroolefin (CFO), hydrochloroolefin (HCO), hydrofluoroolefin (HFO), hydrochlorofluoroolefin (HCFO), hydrofluoroether (HFE), hydrofluoroolefinic ether (HFOE), fluoroketone (FK), hydrofluoroketone (HFK) and mixtures of two or more, a2) optionally identifying contaminants of a1); a3) selecting physical and/or chemical treatments based on a1) and optionally on a2); a4) treating the unreclaimed halogenated liquids of a1) and a2) using the physical and/or chemical treatments selected in step a3) to produce at least a partially reclaimed halogenated liquid; a5) comparing the purity of the at least partially reclaimed halogenated liquid of a3) against an industry standard; a6) optionally, further treating the partially unreclaimed halogenated liquids of a3) to produce a completely reclaimed halogenated liquid; a7) optionally comparing the purity of the at least partially reclaimed halogenated liquid of a5) against an industry standard; a8) optionally, compositionally rebalancing the partially or completely reclaimed halogenated liquid to be industry compliant product; and a9) collecting or packaging the product of a8).

A process embodiment where the spent waste of a) comprises halogenated hydrocarbon generated foams, and ab) the foams are crushed under vacuum to produce crushed foam and a vapor stream, and the vapor stream is removed from the crushed foam.

A process embodiment where the crushed foam of ab) is isolated and pelletized.

A process embodiment where the spent halogenated liquid of a) or the unreclaimed halogenated liquid of a1) is selected from one of HFO-E/Z-1336mzz, HCFO-Z-1224 yd, HCFO-E-1233zd, R-514A (olefin blend comprised of cis-1,1,1,4,4,4-hexafluorobut-2-ene (R-1336mzz (Z)) and trans-1,2-dichloroethene (R-1130 (E), HFO-Z/E 1336mzz blends, liquid HFC-245fa and Vertrel XF.

A process embodiment where the spent halogenated liquid of a) or the unreclaimed halogenated liquid of a1) is selected from one of Vertrel XF, SF10, SF79, SF80, SF01, SF05, SF30, SF33, F33E, F22E and F44E (see Tables 1-4).

A process embodiment where the spent halogenated liquid of a) or the unreclaimed halogenated liquid of a1) is selected from halogenated liquid comprises one of a hydrofluoroether (HFE) and a hydrofluoroolefinic ether (HFOE).

A process embodiment where the spent halogenated liquid of a) or the unreclaimed halogenated liquid of a1) is a hydrofluoroether (HFE) and comprises one of Novec 7100, Novec 7200, Novec 7300, Novec 7500, Novec 71DE, Novec 71DA, Novec 72DA, Novec 72DE, Novec 71IPA, and Novec 73DE (see Table 1).

A process embodiment where the spent halogenated liquid of a) or the unreclaimed halogenated liquid of a1) comprises chlorofluoroolefins (CFOs), hydrochloroolefins (HCOs), hydrochlorofluoroolefins (HCFOs), fluoroketones (FKs) or hydrofluoroketones (HFKs).

A process embodiment where the spent halogenated liquid of a) or the unreclaimed halogenated liquid of a1) is reclaimed and a tracer is added to at least one of the partially reclaimed or completely reclaimed halogenated liquid.

A process embodiment where the spent halogenated liquid of a) or the unreclaimed halogenated liquid of a1) is reclaimed a stabilizer package is added to at least one of the partially reclaimed or completely reclaimed halogenated liquids and includes at least one antioxidant, at least one acid acceptor and at least one metal stabilizer where the antioxidant is selected from butylated hydroxytoluene, butylated hydroxyanisole, tertiary-butylhydroquinone, 4-methoxyphenol, propyl 3,4,5-trihydroxybenzoate, the acid acceptor is selected from epoxy butane, amine and acetaldehyde di-methylhydrazone (ADH), and the metal stabilizer is selected from N,N′-bis(salicylidene)-1,2-propanediamine, benzotriazole and its derivatives.

A process embodiment where the spent halogenated liquid of a) or the unreclaimed halogenated liquid of a1) comprises HFO-E/Z-1336mzz and HFO-Z/E 1336mzz blends.

A process embodiment where the spent halogenated liquid of a) or the unreclaimed halogenated liquid of a1) comprises HCFO-E/Z-1224 yd.

A process embodiment where the spent halogenated liquid of a) or the unreclaimed halogenated liquid of a1) comprises HCFO-E/Z-1233zd.

A process embodiment where the spent halogenated liquid of a) or the unreclaimed halogenated liquid of a1) comprises cis-1,1,1,4,4,4-hexafluorobut-2-ene (R-1336mzz (Z)) and trans-1,2-dichloroethene (R-1130 (E)).

A process embodiment where the spent halogenated liquid of a) or the unreclaimed halogenated liquid of a1) comprises Vertrel XF (1,1,1,2,3,4,4,5,5,5-decafluoropentane).

A process embodiment where the spent halogenated liquid of a) or the unreclaimed halogenated liquid of a1) comprises one of MPHE (Opteon™ SF10); a blend comprising 94% trans-1,2-dichloroethylene, 5% MPHE and 1% Vertrel XF (1,1,1,2,3,4,4,5,5,5-decafluoropentane) (Opteon™ SF79); a blend comprising 94% trans-1,2-dichloroethylene, 5% MPHE and 1% Z-1336mzz (Opteon™ SF80); a blend comprising 98.4% Z-1336mzz and 1.6% ethanol (Opteon™ SF01); a blend comprising 60% Z-1336mzz, 25% MPHE and 15% ethanol (Opteon™ SF05); a blend comprising 75% Z-1336mzz and 25% trans-1,2-dichloroethylene (Opteon™ SF30); (Z)-1,1,1,4,4,4-hexafluoro-2-butene (Opteon™ SF33); 1,1,1,2,2,3,3,6,6,7,7,8,8,8-tetradecafluoro-4-octene (F33E); 1,1,1,2,2,5,5,6,6,6-decafluorohex-3-ene (F22E); and 1,1,1,2,2,3,3,4,4,7,7,8,8,9,9,10,10,10-octadecafluorodec-5-ene (F44E).

A process embodiment where the spent halogenated liquid of a) or the unreclaimed halogenated liquid of a1) comprises chlorofluoroolefins.

A process embodiment where the spent halogenated liquid of a) or the unreclaimed halogenated liquid of a1) comprises hydrofluoroketones (HFK) s

A composition embodiment of the spent halogenated liquid of a) or the unreclaimed halogenated liquid of a1) partially or completely reclaimed.

A system or method of using embodiments comprising one or more of:
an unreclaimed liquid recovery station;
a waste foam collecting station;
a weighing/quantity and testing station comprising analytical systems to determine physical and chemical properties of the unreclaimed liquid selected from one of HFO-E/Z-1336mzz; HCFO-E/Z-1224 yd; HCFO-E/Z-1233zd; R-514A (olefin blend comprised of cis-1,1, 1,4,4,4-hexafluorobut-2-ene (R-1336mzz (Z)) and trans-1,2-dichloroethene (R-1130 (E)); HFO-Z/E 1336mzz blends; liquid HFC-245fa; 1,1,1,2,3,4,4,5,5,5-decafluoropentane (Vertrel XF); MPHE (Opteon™ SF10); a blend comprising 94% trans-1,2-dichloroethylene, 5% MPHE and 1% Vertrel XF (1,1,1,2,3,4,4,5,5,5-decafluoropentane) (Opteon™ SF79); a blend comprising 94% trans-1,2-dichloroethylene, 5% MPHE and 1% Z-1336mzz (Opteon™ SF80); a blend comprising 98.4% Z-1336mzz and 1.6% ethanol (Opteon™ SF01); a blend comprising 60% Z-1336mzz, 25% MPHE and 15% ethanol (Opteon™ SF05); a blend comprising 75% Z-1336mzz and 25% trans-1,2-dichloroethylene (Opteon™ SF30); (Z)-1,1, 1,4,4,4-hexafluoro-2-butene (Opteon™ SF33); 1,1,1,2,2,3,3,6,6,7,7,8,8,8-tetradecafluoro-4-octene (F33E); 1,1,1,2,2,5,5,6,6,6-decafluorohex-3-ene (F22E); and 1,1,1,2,2,3,3,4,4,7,7,8,8,9,9,10,10,10-octadecafluorodec-5-ene (F44E);
a waste foam treatment station comprising at least one crusher, at least one solids sorter, at least one pelletizer with vapor separation;
a first purification system for receiving and treating unreclaimed liquid from said weighing, testing station, vapor from said waste foam treatment station and first transport lines;
a second purification system for receiving and treating liquid from the first purification system, and second transport lines;
a target refrigerant system in flow communication with the first and second transport lines to receive treated liquid from the first and second purification systems for adjusting levels of reclaimed liquid components to target refrigerant levels of the AHRI 700 standards following purification at said first and second purification stations, including a blending station to provide reclaimed liquid blends components consistent with AHRI 700 standards;
a stabilizer package dispensing station to add effective quantities of stabilizer package comprising at least one antioxidant, at least one acid acceptor and at least one metal stabilizer; and,
a purity check station to check the purity of unreclaimed liquid before purification, after the first and/or second purification treatments, and of the at least one first treated product and determining whether or not the first treated product meets or exceeds AHRI 700 standards

A system or method of using embodiment where the weighing and testing station include a scale at least one of a GC-FID, GC-TCD, GC-MS, FTIR, Goetz Bub, Karl Fischer, and Byk-Garner Color detector.

A system or method of using embodiment where the weighing and testing station include one of infrared sensors, UV sensors, NIR sensors, ion mobility or plasma chromatographs, gas chromatography, refractometry, mass spectroscopy, high temperature thick film sensors, thin film field effect sensors, pellistor sensors, Taguchi sensors and quartz microbalance sensors.

A system or method of using embodiment where the weighing and testing station include a scale, GC-MS and Taguchi sensor.

A system or method of using embodiment where at least one of the first and second purification systems include one of a distillation column, and adsorption/desorption column, and cryogenic cooler.

A system or method of using embodiment where at least one of the first and second purification systems include one an NCG purge units, a water distillation or desiccant dryer unit, a solids filter unit, and an acidity neutralizer, and a high distillation residue column.

A process of using embodiment of exchanging heat using reclaimed compositions of (a) formula CF₃(CF₂)ₓCF═CFCF(OR)(CF₂)_{y}CF₃, CF₃(CF₂)ₓC(OR)═CFCF₂(CF₂)_{y}CF₃, CF₃CF═CFCF(OR)(CF₂)ₓ(CF₂)_{y}CF₃, CF₃(CF₂)ₓCF═C(OR)CF₂(CF₂)_{y}CF₃, or mixtures thereof, wherein R can be either CH₃, C₂H₅ or mixtures thereof, and wherein x and y are independently 0, 1, 2 or 3, and wherein x+y=0, 1, 2 or 3; the compounds of (b) formulas CF₃(CF₂)ₓCF═CFCF(OR)(CF₂)_{y}CF₃, CF₃(CF₂)ₓC(OR)—CFCF₂(CF₂)_{y}CF₃, CF₃CF-CFCF(OR)(CF₂)ₓ(CF₂)_{y}CF₃, CF₃(CF₂)ₓCF═C(OR)CF₂(CF₂)_{y}CF₃, and mixtures thereof; wherein x and y are independently 0, 1, 2, 3 or 4 and wherein x+y=0, 1, 2, 3 or 4; and wherein R is 2,2,3,3-tetrafluoro-1-propyl, 2,2,3,3,3-pentafluoro-1-propyl, 2,2,2-trifluoro-1-ethyl, 2,2,3,3,4,4,5,5-octafluoro-1-pentyl, or 1, 1,1,3,3,3-hexafluoro-2-propyl; and (c) mixtures of compounds from (a) and (b), including but not limited to 5-methoxyperfluoro-3-heptene, 3-methoxyperfluoro-3-heptene, 4-methoxyperfluoro-2-heptene, 3-methoxyperfluoro-2-heptene, or mixtures thereof; at least one of 4-methoxyperfluoro-2-pentene, 2-methoxyperfluoro-2-pentene, 3-methoxyperfluoro-2-pentene, 2-methoxyperfluoro-3-pentene, or mixtures thereof; and at least one of cis- and trans-2-methoxyperfluoro-2-octene, 2-methoxyperfluoro-3-octene, or mixtures thereof.

A process of using embodiments of exchanging heat using reclaimed hydrofluoroethers (HFEs), e.g., methoxy-nonafluorobutane (Novec™ 7100); ethoxy-nonafluorobutane (Novec™ 7200); 1,1,1,2,2,3,4,5,5,5-decafluoro 3-methoxy-4-(trfluoromethyl) pentane (Novec™ 7300); 3-ethoxy-1,1,1,2,3,4,4,5,5,6,6,6-dodecafluoro-2-(trifluoromethyl) hexane (Novec™ 7500); dodecafluoro-2-methylpentan-3-one (Novec™ 649); blend comprising 50% methyl nonafluorobutyl ether and 50% trans-1,2-dichloroethylene (Novec™ 71DE); blend comprising 52.7% methyl nonafluorobutyl ether, 44.6% trans-1,2-dichloroethylene and 2.7% ethanol (Novec™ 71DA); blend comprising 10% methyl nonafluorobutyl ether, 20% ethyl nonafluorobutyl ether, 68% trans-1,2-dichloroethylene and 2% isopropanol (Novec™ 72DA); blend comprising 10% methyl nonafluorobutyl ether, 20% ethyl nonafluorobutyl ether and 70% trans-1,2-dichloroethylene (Novec™ 72DE); blend comprising 95.5% methyl nonafluorobutyl ether and 4.5% isopropanol (Novec™ 71IPA), and/or blend comprising 1,1,1,2,2,3,4,5,5,5-decafluoro 3-methoxy-4-(trfluoromethyl) pentane and trans-1,2-dichloroethylene (Novec™ 73DE).

A process of using embodiments of exchanging heat using reclaimed hydrofluoroketones (HFK), including but not limited to trifluoroacetone, dodecafluoro-2-methylpentan-3-one (Novec 649).

A process of using embodiments of exchanging heat using reclaimed fluids selected from HFO-E/Z-1336mzz; HCFO-E/Z-1224 yd; HCFO-E/Z1233zd; R-514A (olefin blend comprised of cis-1,1,1,4,4,4-hexafluorobut-2-ene (R-1336mzz (Z)) and trans-1,2-dichloroethene (R-1130 (E)); HFO-Z/E 1336mzz blends; liquid HFC-245fa; 1,1,1,2,3,4,4,5,5,5-decafluoropentane (Vertrel XF); MPHE (Opteon™ SF10); a blend comprising 94% trans-1,2-dichloroethylene, 5% MPHE and 1% Vertrel XF (1,1,1,2,3,4,4,5,5,5-decafluoropentane) (Opteon™ SF79); a blend comprising 94% trans-1,2-dichloroethylene, 5% MPHE and 1% Z-1336mzz (Opteon™ SF80); a blend comprising 98.4% Z-1336mzz and 1.6% ethanol (Opteon™ SF01); a blend comprising 60% Z-1336mzz, 25% MPHE and 15% ethanol (Opteon™ SF05); a blend comprising 75% Z-1336mzz and 25% trans-1,2-dichloroethylene (Opteon™ SF30); (Z)-1,1,1,4,4,4-hexafluoro-2-butene (Opteon™ SF33); 1,1,1,2,2,3,3,6,6,7,7,8,8,8-tetradecafluoro-4-octene (F33E); 1,1,1,2,2,5,5,6,6,6-decafluorohex-3-ene (F22E); and 1,1,1,2,2,3,3,4,4,7,7,8,8,9,9,10,10,10-octadecafluorodec-5-ene (F44E).

A process of using embodiments of exchanging heat using reclaimed fluorinated and perfluorinated C₄-C₇ unsaturated compounds, such as 1, 1, 1,2,3,4,4,4-octafluoro-2-butene (CF₃CF═CFCF₃); 1,1,2,3,3,4,4,4-octafluoro-1-butene (CF₃CF₂CF═CF₂); 1,1, 1,2,4,4,4-heptafluoro-2-butene (CF₃CF═CHCF₃); 1,2,3,3,4,4,4-heptafluoro-1-butene (CHF═CFCF₂CF₃); 1,1,1,2,3,4,4-heptafluoro-2-butene (CHF₂CF═CFCF₃); 1,3,3,3-tetrafluoro-2-(trifluoromethyl)-1-propene ((CF₃)₂C═CHF); 1,1,3,3,4,4,4-heptafluoro-1-butene (CF₂-CHCF₂CF₃); 1,1,2,3,4,4,4-heptafluoro-1-butene (CF₂═CFCHFCF₃); 1,1,2,3,3,4,4-heptafluoro-1-butene (CF₂═CFCF₂CHF₂); 2,3,3,4,4,4-hexafluoro-1-butene (CF₃CF₂CF═CH₂); 1,3,3,4,4,4-hexafluoro-1-butene (CHF═CHCF₂CF₃); 1,2,3,4,4,4-hexafluoro-1-butene (CHF═CFCHFCF₃); 1,2,3,3,4,4-hexafluoro-1-butene (CHF═CFCF₂CHF₂); 1, 1,2,3,4,4-hexafluoro-2-butene (CHF₂CF═CFCHF₂); 1,1,1,2,3,4-hexafluoro-2-butene (CH₂FCF═CFCF₃); 1,1,1,2,4,4-hexafluoro-2-butene (CHF₂CH═CFCF₃); 1, 1, 1,3,4,4-hexafluoro-2-butene (CF₃CH═CFCHF₂); 1, 1,2,3,3,4-hexafluoro-1-butene (CF₂-CFCF₂CH₂F); 1,1,2,3,4,4-hexafluoro-1-butene (CF₂═CFCHFCHF₂); 3,3,3-trifluoro-2-(trifluoromethyl)-1-propene (CH₂-C(CF₃)₂); 1,1,1,2,4-pentafluoro-2-butene (CH₂FCH═CFCF₃); 1,1,1,3,4-pentafluoro-2-butene (CF₃CH═CFCH₂F); 3,3,4,4,4-pentafluoro-1-butene (CF₃CF₂CH═CH₂); 1,1,1,4,4-pentafluoro-2-butene (CHF₂CH═CHCF₃); 1,1, 1,2,3-pentafluoro-2-butene (CH₃CF═CFCF₃); 2,3,3,4,4-pentafluoro-1-butene (CH₂═CFCF₂CHF₂); 1,1,2,4,4-pentafluoro-2-butene (CHF₂CF═CHCHF₂); 1,1,2,3,3-pentafluoro-1-butene (CH₃CF₂CF-CF₂); 1,1,2,3,4-pentafluoro-2-butene (CH₂FCF═CFCHF₂); 1,1,3,3,3-pentafluoro-2-methyl-1-propene (CF₂-C(CF₃)(CH₃)); 2-(difluoromethyl)-3,3,3-trifluoro-1-propene (CH₂-C(CHF₂)(CF₃)); 2,3,4,4,4-pentafluoro-1-butene (CH₂═CFCHFCF₃); 1,2,4,4,4-pentafluoro-1-butene (CHF═CFCH₂CF₃); 1,3,4,4,4-pentafluoro-1-butene (CHF═CHCHFCF₃); 1,3,3,4,4-pentafluoro-1-butene (CHF═CHCF₂CHF₂); 1,2,3,4,4-pentafluoro-1-butene (CHF═CFCHFCHF₂); 3,3,4,4-tetrafluoro-1-butene (CH₂═CHCF₂CHF₂); 1, 1-difluoro-2-(difluoromethyl)-1-propene (CF₂═C(CHF₂)(CH₃)); 1,3,3,3-tetrafluoro-2-methyl-1-propene (CHF═C(CF₃)(CH₃)); 3,3-difluoro-2-(difluoromethyl)-1-propene (CH₂═C(CHF₂)₂); 1,1,1,2-tetrafluoro-2-butene (CF₃CF═CHCH₃); 1, 1, 1,3-tetrafluoro-2-butene (CH₃CF═CHCF₃); 1, 1, 1,2,3,4,4,5,5,5-decafluoro-2-pentene (CF₃CF═CFCF₂CF₃); 1,1,2,3,3,4,4,5,5,5-decafluoro-1-pentene (CF₂-CFCF₂CF₂CF₃); 1,1,1,4,4,4-hexafluoro-2-(trifluoromethyl)-2-butene ((CF₃)₂C-CHCF₃); 1,1,1,2,4,4,5,5,5-nonafluoro-2-pentene (CF₃CF-CHCF₂CF₃); 1,1,1,3,4,4,5,5,5-nonafluoro-2-pentene (CF₃CH═CFCF₂CF₃); 1,2,3,3,4,4,5,5,5-nonafluoro-1-pentene (CHF═CFCF₂CF₂CF₃); 1,1,3,3,4,4,5,5,5-nonafluoro-1-pentene (CF₂-CHCF₂CF₂CF₃); 1,1,2,3,3,4,4,5,5-nonafluoro-1-pentene (CF₂-CFCF₂CF₂CHF₂); 1,1,2,3,4,4,5,5,5-nonafluoro-2-pentene (CHF₂CF═CFCF₂CF₃); 1,1,1,2,3,4,4,5,5-nonafluoro-2-pentene (CF₃CF═CFCF₂CHF₂); 1,1,1,2,3,4,5,5,5-nonafluoro-2-pentene (CF₃CF═CFCHFCF₃); 1,2,3,4,4,4-hexafluoro-3-(trifluoromethyl)-1-butene (CHF═CFCF(CF₃)₂); 1,1,2,4,4,4-hexafluoro-3-(trifluoromethyl)-1-butene (CF₂-CFCH(CF₃)₂); 1,1,1,4,4,4-hexafluoro-2-(trifluoromethyl)-2-butene (CF₃CH═C(CF₃)₂); 1,1,3,4,4,4-hexafluoro-3-(trifluoromethyl)-1-butene (CF₂═CHCF(CF₃)₂); 2,3,3,4,4,5,5,5-octafluoro-1-pentene (CH₂═CFCF₂CF₂CF₃); 1,2,3,3,4,4,5,5-octafluoro-1-pentene (CHF═CFCF₂CF₂CHF₂); 3,3,4,4,4-pentafluoro-2-(trifluoromethyl)-1-butene (CH₂-C(CF₃)CF₂CF₃); 1,1,4,4,4-pentafluoro-3-(trifluoromethyl)-1-butene (CF₂-CHCH(CF₃)₂); 1,3,4,4,4-pentafluoro-3-(trifluoromethyl)-1-butene (CHF-CHCF(CF₃)₂); 1,1,4,4,4-pentafluoro-2-(trifluoromethyl)-1-butene (CF₂═C(CF₃) CH₂CF₃); 3,4,4,4-tetrafluoro-3-(trifluoromethyl)-1-butene ((CF₃)₂CFCH═CH₂); 3,3,4,4,5,5,5-heptafluoro-1-pentene (CF₃CF₂CF₂CH—CH₂); 2,3,3,4,4,5,5-heptafluoro-1-pentene (CH₂-CFCF₂CF₂CHF₂); 1, 1,3,3,5,5,5-heptafluoro-1-butene (CF₂═CHCF₂CH₂CF₃); 1,1,1,2,4,4,4-heptafluoro-3-methyl-2-butene (CF₃CF═C(CF₃)(CH₃)); 2,4,4,4-tetrafluoro-3-(trifluoromethyl)-1-butene (CH₂═CFCH(CF₃)₂); 1,4,4,4-tetrafluoro-3-(trifluoromethyl)-1-butene (CHF═CHCH(CF₃)₂); 1, 1, 1,4-tetrafluoro-2-(trifluoromethyl)-2-butene (CH₂FCH—C(CF₃)₂); 1,1,1,3-tetrafluoro-2-(trifluoromethyl)-2-butene (CH₃CF-C(CF₃)₂); 1,1,1-trifluoro-2-(trifluoromethyl)-2-butene ((CF₃)₂C═CHCH₃); 3,4,4,5,5,5-hexafluoro-2-pentene (CF₃CF₂CF═CHCH₃); 1, 1, 1,4,4,4-hexafluoro-2-methyl-2-butene (CF₃C(CH₃)═CHCF₃); 3,3,4,5,5,5-hexafluoro-1-pentene (CH₂═CHCF₂CHFCF₃); 4,4,4-trifluoro-2-(trifluoromethyl)-1-butene (CH₂═C(CF₃) CH₂CF₃); 1,1,2,3,3,4,4,5,5,6,6,6-dodecafluoro-1-hexene (CF₃(CF₂)₃CF-CF₂); 1,1,1,2,2,3,4,5,5,6,6,6-dodecafluoro-3-hexene (CF₃CF₂CF═CFCF₂CF₃); 1,1,1,4,4,4-hexafluoro-2,3-bis(trifluoromethyl)-2-butene ((CF₃)₂C═C(CF₃)₂); 1,1,1,2,3,4,5,5,5-nonafluoro-4-(trifluoromethyl)-2-pentene ((CF₃)₂CFCF═CFCF₃); 1,1,1,4,4,5,5,5-octafluoro-2-(trifluoromethyl)-2-pentene ((CF₃)₂C═CHC₂F₅); 1,1,1,3,4,5,5,5-octafluoro-4-(trifluoromethyl)-2-pentene ((CF₃)₂CFCF-CHCF₃); 3,3,4,4,5,5,6,6,6-nonafluoro-1-hexene (CF₃CF₂CF₂CF₂CH═CH₂); 4,4,4-trifluoro-3,3-bis(trifluoromethyl)-1-butene (CH₂═CHC(CF₃)₃); 1,1,1,4,4,4-hexafluoro-3-methyl-2-(trifluoromethyl)-2-butene ((CF₃)₂C═C(CH₃)(CF₃)); 2,3,3,5,5,5-hexafluoro-4-(trifluoromethyl)-1-pentene (CH₂-CFCF₂CH(CF₃)₂); 1,1,1,2,4,4,5,5,5-nonafluoro-3-methyl-2-pentene (CF₃CF═C(CH₃)CF₂CF₃); 1,1,1,5,5,5-hexafluoro-4-(trifluoromethyl)-2-pentene (CF₃CH═CHCH(CF₃)₂); 3,4,4,5,5,6,6,6-octafluoro-2-hexene (CF₃CF₂CF₂CF═CHCH₃); 3,3,4,4,5,5,6,6-octafluoro1-hexene (CH₂-CHCF₂CF₂CF₂CHF₂); 1,1,1,4,4-pentafluoro-2-(trifluoromethyl)-2-pentene ((CF₃)₂C═CHCF₂CH₃); 4,4,5,5,5-pentafluoro-2-(trifluoromethyl)-1-pentene (CH₂-C(CF₃) CH₂C₂F₅); 3,3,4,4,5,5,5-heptafluoro-2-methyl-1-pentene (CF₃CF₂CF₂C(CH₃)═CH₂); 4,4,5,5,6,6,6-heptafluoro-2-hexene (CF₃CF₂CF₂CH═CHCH₃); 4,4,5,5,6,6,6-heptafluoro-1-hexene (CH₂═CHCH₂CF₂C₂F₅); 1,1,1,2,2,3,4-heptafluoro-3-hexene (CF₃CF₂CF═CFC₂H₅); 4,5,5,5-tetrafluoro-4-(trifluoromethyl)-1-pentene (CH₂-CHCH₂CF(CF₃)₂); 1, 1, 1,2,5,5,5-heptafluoro-4-methyl-2-pentene (CF₃CF═CHCH(CF₃)(CH₃)); 1,1,1,3-tetrafluoro-2-(trifluoromethyl)-2-pentene ((CF₃)₂C═CFC₂H₅); 1, 1,1,2,3,4,4,5,5,6,6,7,7,7-tetradecafluoro-2-heptene (CF₃CF═CFCF₂CF₂C₂F₅); 1, 1,1,2,2,3,4,5,5,6,6,7,7,7-tetradecafluoro-3-heptene (CF₃CF₂CF-CFCF₂C₂F₅); 1,1,1,3,4,4,5,5,6,6,7,7,7-tridecafluoro-2-heptene (CF₃CH—CFCF₂CF₂C₂F₅); 1, 1,1,2,4,4,5,5,6,6,7,7,7-tridecafluoro-2-heptene (CF₃CF═CHCF₂CF₂C₂F₅); 1, 1,1,2,2,4,5,5,6,6,7,7,7-tridecafluoro-3-heptene (CF₃CF₂CH═CFCF₂C₂F₅); 1,1,1,2,2,3,5,5,6,6,7,7,7-tridecafluoro-3-heptene (CF₃CF₂CF═CHCF₂C₂F₅) alone, or in admixture with other HFO, HCFO and HFC compounds.

A process of using embodiments of exchanging heat using reclaimed fluid selected from 1,1,1,2,3,4,4,5,5,5-decafluoropentane (Vertrel XF); MPHE (Opteon™ SF10); a blend comprising 94% trans-1,2-dichloroethylene, 5% MPHE and 1% Vertrel XF (1,1,1,2,3,4,4,5,5,5-decafluoropentane) (Opteon™ SF79); a blend comprising 94% trans-1,2-dichloroethylene, 5% MPHE and 1% Z-1336mzz (Opteon™ SF80); a blend comprising 98.4% Z-1336mzz and 1.6% ethanol (Opteon™ SF01); a blend comprising 60% Z-1336mzz, 25% MPHE and 15% ethanol (Opteon™ SF05); a blend comprising 75% Z-1336mzz and 25% trans-1,2-dichloroethylene (Opteon™ SF30); (Z)-1,1,1,4,4,4-hexafluoro-2-butene (Opteon™ SF33); 1,1,1,2,2,3,3,6,6,7,7,8,8,8-tetradecafluoro-4-octene (F33E); 1,1,1,2,2,5,5,6,6,6-decafluorohex-3-ene (F22E); and 1, 1,1,2,2,3,3,4,4,7,7,8,8,9,9,10,10,10-octadecafluorodec-5-ene (F44E).

A process of using embodiments of exchanging heat using a reclaimed fluoroketone (FK) or hydrofluoroketone (HF).

A process of using embodiments of using reclaimed halogenated liquids selected from one of hydrofluoroolefin (HFO), hydrochlorofluoroolefin (HCFO), hydrofluoroether (HFE), hydrofluoroolefinic ether (HFOE) as aerosol propellants, refrigerants, cleaning agents, expansion agents for thermoplastic and thermoset foams, heat transfer media, liquid dielectrics, power cycle working fluids, polymerization media, particulate removal fluids, carrier fluids, buffing abrasive agents, and displacement drying agents heat exchanging.

A heat exchanging embodiment comprising charging a system with a working fluid selected from at least one of reclaimed hydrofluoroolefins (HFOs), hydrochlorofluoroolefin (HCFOs), hydrofluoroethers (HFEs), hydrofluoroolefinic ether (HFOEs), and circulating the working fluid.

A cooling embodiment cooling comprising directly contacting an electrical component with at least one reclaimed hydrofluoroolefin (HFO), hydrochlorofluoroolefin (HCFO), hydrofluoroethers (HFE), hydrofluoroolefinic ether (HFOE).

A heat exchanging embodiment comprising charging a system with a working fluid selected from at least one of a reclaimed fluoroketone (FK) or hydrofluoroketone (HFK) and circulating the working fluid.

A cooling embodiment cooling comprising directly contacting an electrical component with at least one of a reclaimed fluoroketone (FK) or hydrofluoroketone (HFK).

A process embodiment comprising using at least one reclaimed hydrofluoroolefin (HFO), hydrochlorofluoroolefin (HCFO), hydrofluoroethers (HFE), hydrofluoroolefinic ether (HFOE) in refrigeration, in air conditioning, in heating, in heat transfer, in conversion of heat into mechanical work in a power cycle, as a foam blowing agent, as a solvent, or in preventing or quenching an electric discharge.

A process embodiment comprising using at least one reclaimed hydrofluoroolefin (HFO), hydrochlorofluoroolefin (HCFO), hydrofluoroethers (HFE), hydrofluoroolefinic ether (HFOE), hydrofluoroketone (HFK). with a refrigerant component, an air conditioning component, a heating component, a heat transfer component, a working fluid component, a blowing agent component, a solvent component, or a dielectric component.

A process embodiment comprising using at least one reclaimed fluoroketone (FK) or hydrofluoroketone (HFK) in refrigeration, in air conditioning, in heating, in heat transfer, in conversion of heat into mechanical work in a power cycle, as a foam blowing agent, as a solvent, or in preventing or quenching an electric discharge.

A process embodiment comprising at least one reclaimed fluoroketone (FK) or hydrofluoroketone (HFK) with a refrigerant component, an air conditioning component, a heating component, a heat transfer component, a working fluid component, a blowing agent component, a solvent component, or a dielectric component.

A composition embodiment comprising one or more reclaimed compounds and the compound that has been reclaimed is one of the compounds listed in Table 1, optionally containing a tracer.

A composition embodiment comprising one or more reclaimed compounds and the compound that has been reclaimed is one of the compounds listed in Table 2, optionally containing a tracer.

A composition embodiment comprising one or more reclaimed compounds and the compound that has been reclaimed is one of the compounds listed in Table 3, optionally containing a tracer.

A composition embodiment comprising one or more reclaimed compounds and the compound that has been reclaimed is one of the compounds listed in Table 4, optionally containing a tracer.

In some embodiments, for any of the composition and process embodiment disclosed herein, HFO-E/Z-1336mzz comprises HFO-E 1336mzz, HFO-Z 1336mzz and mixtures of HFO-E 1336mzz and HFO-Z 1336mzz; HFO-E/Z-1224 yd comprises HFO-E 1336mzz, HFO-Z 1224 yd and mixtures of HFO-E 1224 yd and HFO-Z 1224 yd; and HCFO-E/Z-1233zd comprises HCFO-E-1233zd, HCFO-Z-1233zd and mixtures of HCFO-E-1233zd and HCFO-Z-1233zd.

Although certain aspects, embodiments and principals have been described above, it is understood that this description is made only way of example and not as limitation of the scope of the invention or appended claims. The foregoing various aspects, embodiments and principals can be used alone and in combinations with each other.

1.-55. (canceled)

56. A process comprising:
a) treating spent halogenated liquids to produce reclaimed halogenated liquids, wherein the spent halogenated liquids is selected from the group consisting of refrigerants, refrigerant blends, blowing agents, solvent, and immersion coolants, and
b) collecting or packaging the reclaimed halogenated liquids.

57. The process of claim 56, wherein the spent halogenated liquids comprise at least one of hydrochloroolefin (HCO), hydrofluoroolefin (HFO), hydrochlorofluoroolefin (HCFO), hydrofluoroether (HFE), hydrofluoroolefinic ether (HFOE), chlorofluoroolefin (CFO), fluoroketone, or hydrofluoroketone (HFK).

58. The process of claim 57, wherein the hydrofluoroether (HFE) comprises a liquid selected from the group consisting of methoxy-nonafluorobutane; ethoxy-nonafluorobutane; 1,1,1,2,2,3,4,5,5,5-decafluoro 3-methoxy-4-(trfluoromethyl) pentane; 3-ethoxy-1,1,1,2,3,4,4,5,5,6,6,6-dodecafluoro-2-(trifluoromethyl) hexane; blend comprising 50% methyl nonafluorobutyl ether and 50% trans-1,2-dichloroethylene; blend comprising 52.7% methyl nonafluorobutyl ether, 44.6% trans-1,2-dichloroethylene and 2.7% ethanol; blend comprising 10% methyl nonafluorobutyl ether, 20% ethyl nonafluorobutyl ether, 68% trans-1,2-dichloroethylene and 2% isopropanol; blend comprising 10% methyl nonafluorobutyl ether, 20% ethyl nonafluorobutyl ether and 70% trans-1,2-dichloroethylene; blend comprising 95.5% methyl nonafluorobutyl ether and 4.5% isopropanol, and/or blend comprising 1,1,1,2,2,3,4,5,5,5-decafluoro 3-methoxy-4-(trfluoromethyl) pentane and trans-1,2-dichloroethylene.

59. The process of claim 56, wherein the spent halogenated liquids are collected from unreclaimed halogenated liquids prior to a).

60. The process of claim 59, wherein, prior to a), the unreclaimed halogenated liquids are analyzed to determine (i) the composition of the unreclaimed halogenated liquids and the presence and nature of any contaminants; or (ii) physical and chemical properties of the unreclaimed halogenated liquids.

61. The process as in claim 60, wherein the unreclaimed halogenated liquids are analyzed using at least one analytical technique selected from the group consisting of GC-FID, GC-TCD, GC-MS, FTIR, Goetz Bub, Karl Fischer, Byk-Garner Color.

62. The process of claim 56, wherein the treating comprises at least one treatment selected from the group consisting of distillation, adsorption, desorption, cryogenic cooling, moisture removal, a contaminant removal, solids filters, acidity neutralization, and high boiling residue/chloride distillation.

63. The process of claim 56, wherein the spent halogenated liquid is selected from the group consisting of: E-1,2-dichloroethene; HFO-E/Z-1336mzz; HCFO-E/Z-1224 yd; HCFO-E/Z-1233zd; R-514A; HFO-Z/E 1336mzz blends; cis-1, 1, 1,4,4,4-hexafluorobut-2-ene (R-1336mzz (Z)) and trans-1,2-dichloroethene (R-1130 (E)); liquid HFC-245fa; 1,1,1,2,3,4,4,5,5,5-decafluoropentane; MPHE; a blend comprising 94% trans-1,2-dichloroethylene, 5% MPHE and 1% 1,1,1,2,3,4,4,5,5,5-decafluoropentane; a blend comprising 94% trans-1,2-dichloroethylene, 5% MPHE and 1% Z-HFO-1336mzz; a blend comprising 98.4% Z-HFO-1336mzz and 1.6% ethanol; a blend comprising 60% Z-HFO-1336mzz, 25% MPHE and 15% ethanol; a blend comprising 75% Z-HFO-1336mzz and 25% trans-1,2-dichloroethylene; (Z)-1,1,1,4,4,4-hexafluoro-2-butene; 1,1,1,4,5,5,5-heptafluoro-4-(trifluoromethyl) pent-2-ene; 1,1,1,2,2,3,3,6,6,7,7,8,8,8-tetradecafluoro-4-octene; 1,1,1,2,2,5,5,6,6,6-decafluorohex-3-ene; and 1,1,1,2,2,3,3,4,4,7,7,8,8,9,9,10,10,10-octadecafluorodec-5-ene.

64. The process of claim 56, further comprising adding to the reclaimed halogenated liquids:
(i) a tracer; and/or
(ii) a stabilizer package including at least one antioxidant, at least one acid acceptor and at least one metal stabilizer, wherein the at least one antioxidant is selected from the group consisting of butylated hydroxytoluene, butylated hydroxyanisole, tertiary-butylhydroquinone, 4-methoxyphenol, propyl 3,4,5-trihydroxybenzoate, the acid acceptor is selected from epoxy butane, amine and acetaldehyde di-methylhydrazone (ADH), and the metal stabilizer is selected from N,N′-bis(salicylidene)-1,2-propanediamine, benzotriazole and its derivatives.

65. A process of exchanging heat comprising circulating the reclaimed halogenated liquid of claim 56, and transferring heat to and from the reclaimed halogenated liquid.

66. A process of exchanging heat comprising charging a system with a working fluid comprising the reclaimed halogenated liquid of claim 56, and circulating the working fluid.

67. A process of cooling electrical components comprising directly contacting the component with the reclaimed halogenated liquid of claim 56.

68. A process comprising:
a) treating foam waste to produce reclaimed foam polymer, and
b) collecting or packaging the reclaimed foam polymer.

69. The process of claim 68, wherein the foam waste is treated by crushing.

70. The process of claim 68, wherein the foam waste are collected from unreclaimed foam waste prior to a).

71. The process of claim 68, wherein the treating comprises at least one treatment selected from the group consisting of distillation, adsorption, desorption, cryogenic cooling, moisture removal, a contaminant removal, solids filters, acidity neutralization, and high boiling residue/chloride distillation.

72. The process of claim 68, wherein the foam waste comprises halogenated hydrocarbon generated foams which are crushed under vacuum to produce crushed foam and a vapor stream.

73. The process of claim 72, wherein the vapor stream is removed from the crushed foam.

74. The process of claim 73, wherein the crushed foam is isolated and pelletized.

75. The process of claim 68, wherein the foam waste is a polyurethane foam which is crushed, pelletized and converted chemically reduced a liquid polyol.

76. An integrated system comprising:
an unreclaimed liquid recovery station;
a weighing and testing station comprising analytical systems to determine physical and chemical properties of an unreclaimed liquid;
a first purification system configured to receive and treat the unreclaimed liquid from said weighing and testing station;
a second purification system configured to receive and treat liquid from the first purification system; and
a target refrigerant system in flow communication with a first transport line to receive treated liquid from the first purification system for adjusting levels of reclaimed liquid components to target refrigerant levels of AHRI 700 standards following purification at said first and second purification stations.

77. The integrated system of claim 76, further comprising a blending station configured to provide reclaimed liquid blends components consistent with AHRI 700 standards.

78. The integrated system of claim 76, further comprising a stabilizer package dispensing station configured to add effective quantities of a stabilizer package comprising at least one antioxidant, at least one acid acceptor and at least one metal stabilizer.

79. The integrated system of claim 76, further comprising a purity check station configured to check the purity of unreclaimed liquid before purification, after the first and/or second purification treatments, and of the at least one first treated product and determining whether or not the first treated product meets or exceeds AHRI 700 standards.

80. The integrated system of claim 76, further comprising a waste foam collecting station and a waste foam treatment station comprising at least one crusher, at least one solids sorter, and at least one pelletizer with vapor separation, wherein the first purification system is configured to receive and treat vapor from said waste foam treatment station, and wherein the second purification system is configured to receive and treat vapor from the first purification system.

81. The integrated system of claim 80, wherein the waste foam treatment station is adapted to crush and pelletize polyurethane foam for one of subsequent use or recycle to a liquid polyol.

82. The integrated system of claim 76, wherein the unreclaimed liquid is selected from the group consisting of HFO-E/Z-1336mzz; HCFO-1224 yd; HCFO-1233zd; R-514A (olefin blend comprised of cis-1,1,1,4,4,4-hexafluorobut-2-ene (R-1336mzz (Z)) and trans-1,2-dichloroethene (R-1130 (E)); HFO-Z/E 1336mzz blends; liquid HFC-245fa; 1,1,1,2,3,4,4,5,5,5-decafluoropentane; MPHE; a blend comprising 94% trans-1,2-dichloroethylene, 5% MPHE and 1% 1,1, 1,2,3,4,4,5,5,5-decafluoropentane; a blend comprising 94% trans-1,2-dichloroethylene, 5% MPHE and 1% Z-1336mzz; a blend comprising 98.4% Z-1336mzz and 1.6% ethanol; a blend comprising 60% Z-1336mzz, 25% MPHE and 15% ethanol; a blend comprising 75% Z-1336mzz and 25% trans-1,2-dichloroethylene; (Z)-1,1,1,4,4,4-hexafluoro-2-butene; 1,1,1,4,5,5,5-heptafluoro-4-(trifluoromethyl) pent-2-ene; 1,1,1,2,2,3,3,6,6,7,7,8,8,8-tetradecafluoro-4-octene; 1,1,1,2,2,5,5,6,6,6-decafluorohex-3-ene; and
1,1,1,2,2,3,3,4,4,7,7,8,8,9,9,10,10,10-octadecafluorodec-5-ene.

83. The integrated system of claim 76, wherein at least one of the first and second purification systems includes at least one of a distillation column, an adsorption/desorption column, a cryogenic cooler, a NCG purge unit, a water distillation or desiccant dryer unit, a solids filter unit, an acidity neutralizer, and a high distillation residue column.
